(19) United States
(12) Patent Application Publication
(10) Pub. No.: US 2006/0212911 A1
(43) Pub. Date: Sep. 21, 2006

(54) System, method and apparatus for wireless delivery of analog media from a media source to a media sink

(75) Inventors: Samuel J. MacMullan, Carlisle, MA (US); Steven S. Fastert, Chelmsford, MA (US); Tandhoni S. Rao, Ashland, MA (US)

Correspondence Address: STERNE, KESSLER, GOLDSTEIN & FOX PLLC, 1100 NEW YORK AVENUE, N.W., WASHINGTON, DC, 20005, US

(73) Assignee: Radiospire Networks, Inc., Concord, MA (US)

(21) Appl. No.: 11/119,726

(22) Filed: May 3, 2005

Related U.S. Application Data
(60) Provisional application No. 60/661,481, filed on Mar. 15, 2005.

(51) Int. Cl. H04N 7/18

(52) U.S. Cl. 725/81

(57) ABSTRACT

A system, method and apparatus for the wireless delivery of analog media from a media sink to a media source. The system, method and apparatus receives analog video and/or analog audio from the media source in respective native formats. The system, method and apparatus converts the received analog video and/or analog audio from respective native formats to a transmission format. The received analog video and/or analog audio is further processed for transmission over a wireless channel. The system, method and apparatus receives and processes the transmitted signal to produce recovered analog video and/or analog audio information. The recovered analog video and/or analog audio information is converted from the transmission format back to the respective native formats for delivery to the media sink. The system, method and apparatus provides a high data rate, low power wireless signal to the media sink at a low bit error rate.

### CROSS REFERENCE TO RELATED APPLICATIONS

This application claims the benefit of U.S. Provisional Patent Application No. 60/661,481, filed Mar. 15, 2005, which is incorporated herein by reference in its entirety. This application is related to U.S. patent application No. (to be determined; Attorney Docket No. 2373.0010001), filed Apr. 29, 2005, which is incorporated herein by reference in its entirety.

### BACKGROUND OF THE INVENTION

1. Field of the Invention

The present invention generally relates to analog media delivery systems. More specifically, the present invention provides the transfer of a low power, high data rate wireless signal containing analog video and/or analog audio information from a media source to a media sink at a low bit error rate.

2. Background Art

An analog media delivery systems transfers analog video signals and/or analog audio signals from a media source to a media sink. Effective delivery of analog video and/or analog audio signals requires the media sink to receive high quality signals. That is, an effective analog media delivery system must be capable of providing large bandwidth (high data rate), high signal-to-noise ratio (low bit error rate) analog audio and/or analog audio signals to a media sink.

Conventional wired delivery systems typically supply the media sink with high quality analog video and/or analog audio signals. Conventional wired systems, however, often require the use of expensive analog cables. In turn, separation between the media source and the media sink suffers. Further, these analog cables aesthetically impair the setup and operation of the media sink and the media source. Installation costs to minimize the exposure of unsightly cables is an expensive solution.

Conventional wireless delivery systems are not burdened by the limitations associated with expensive analog cables. Many conventional wireless delivery systems, however, were designed to accommodate the wireless transfer of generic content. As a result, existing wireless delivery systems are often plagued by low data rates, latency from the need to implement compression/decompression techniques, and the need to share access to limited wireless resources. Because conventional wireless delivery systems are not tailored to the transfer of specific analog video and/or analog audio formats, these systems fail to meet the throughput, quality and cost requirements associated with an effective wireless delivery system.

### BRIEF SUMMARY OF THE INVENTION

Accordingly, the present invention provides an analog media delivery system that minimizes or eliminates the disadvantages of conventional wireless delivery systems. Specifically, the present invention provides the wireless delivery of analog video signals such as Composite Video (CVBS), Super-Video (S-Video), YUV, or Red-Green-Blue (RGB) signals and/or analog line-level audio signals such as RCA or XLR signals. Further, the analog media delivery system of the present invention can be extended to inexpensively supporting multipoint-to-point, point-to-multipoint, or multipoint-to-multipoint connections between one or more media sources and one or more media sinks.

The present invention is directed to a system, method and apparatus for the wireless delivery of analog media from a media sink to a media source. The system, method and apparatus receives analog video and/or analog audio from the media source in respective native formats. The system, method and apparatus converts the received analog video and/or analog audio from respective native formats to a transmission format. The received analog video and/or analog audio is further processed for transmission over a wireless channel. The system, method and apparatus receives and processes the transmitted signal to produce recovered analog video and/or analog audio information. The recovered analog video and/or analog audio information is converted from the transmission format back to the respective native formats for delivery to the media sink. The system, method and apparatus provides a high data rate, low power wireless signal to the media sink at a low bit error rate.

Additional features and advantages of the invention will be set forth in the description that follows, and in part will be apparent from the description, or may be learned by practice of the invention. The advantages of the invention will be realized and attained by the structure and particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS/FIGURES

The accompanying drawings illustrate the present invention and, together with the description, further serve to explain the principles of the invention and to enable one skilled in the pertinent art to make and use the invention.

FIG. 1 illustrates a conventional analog media delivery system for transferring analog audio and analog video signals from a media source to a media sink.

FIG. 2 illustrates a wireless analog media delivery system of the present invention.

FIG. 3 illustrates the wireless transmitter media adapter (or wireless receiver media adapter) depicted in FIG. 2 as a dongle.

FIG. 4 illustrates the attachment of the dongle depicted in FIG. 3 to a display device.

FIG. 5 illustrates the wireless transmitter media adapter (or wireless receiver media adapter) depicted in FIG. 2 in an alternative dongle configuration.

FIG. 6 illustrates a wireless transmitter media adapter for use within an analog media delivery system of the present invention.

FIG. 7 illustrates a wireless receiver media adapter for use within an analog media delivery system of the present invention.

FIG. 8 illustrates a first and second wireless analog media delivery systems of the present invention that use a first wireless channel for the transfer of high data rate analog video and analog audio information and a second wireless channel for the bi-directional exchange of Media Access Control (MAC) information.

FIG. 9 illustrates in more detail the elements of a wireless analog media delivery system of the present invention that uses a first wireless channel for transferring high data rate analog video and analog audio information a second wireless channel for MAC signaling.

FIG. 10 illustrates a bandwidth allocation scheme used by an analog media delivery system of the present invention to accommodate a first wireless channel for transferring high data rate analog video and analog audio information a second wireless channel for MAC signaling.

FIG. 11 illustrates a wireless analog media delivery system of the present invention having multiple wireless transmitter media adapters and multiple wireless receiver media adapters in contention for shared wireless resources.

FIG. 12 an auto-detect and an auto-connect process of the present invention used by a wireless analog media delivery system of the present invention.

FIG. 13 illustrates the insertion of training sequences within a portion of an HDMI frame.

FIG. 14 illustrates the placement of training sequences within a portion of a reformatted HDMI frame in accordance with the present invention.

FIG. 15 illustrates a wireless transmitter media adapter of the present invention that alternately provides encoded data to one of two signal processing paths for transmission over one of two different radio-frequency (RF) channels.

FIG. 16 illustrates a wireless receiver media adapter of the present invention that provides a received signal to two signal processing paths for the reception of data transmitted over two different RF channels.

### DETAILED DESCRIPTION OF THE INVENTION

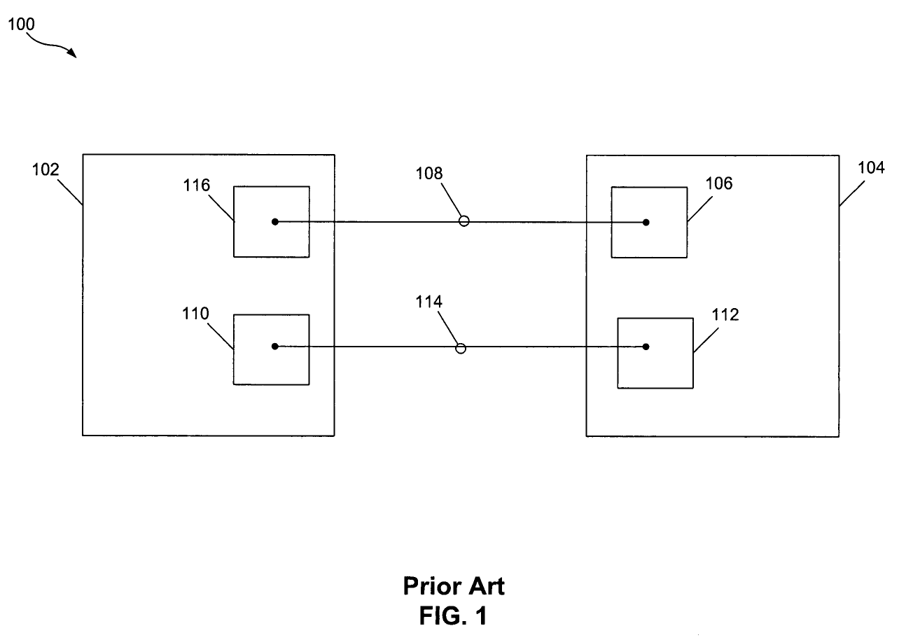

FIG. 1 illustrates a conventional analog media delivery system 100 for transferring analog audio and analog video signals from a media source 102 to a media sink 104. The media source 102 is an audio and/or video source such as, for example, a set-top box, a Digital Video Disc (DVD) player, a Digital-Video Home Standard (D-VHS) player, or an audio/video (A/V) receiver. The media sink 104 can be an audio and video display/presenter such as, for example, an analog television, a digital television, a plasma display, a Liquid Crystal Display (LCD) TV, or a projector. Alternatively, the media sink 104 can be, for example, a Digital Video Recorder (DVR). Generally, the media source 102 can be any media device that provides analog audio and/or analog video signal outputs while the media sink 104 can be any media device capable of receiving and manipulating corresponding analog audio and/or analog video signal inputs.

The media source 102 includes an analog audio output signal interface 116 and an analog video output signal interface 110. The analog audio output signal interface 116 provides an analog audio output signal and the analog video output signal interface 110 provides an analog video output signal. The media sink 104 correspondingly includes an audio input signal interface 106 and an analog video input signal interface 112. The analog audio input signal interface 106 receives an analog audio input signal and the analog video input signal interface 112 receives an analog video input signal.

The conventional analog media delivery system 100 is a wired delivery system. As shown in FIG. 1, the conventional analog media delivery system 100 uses an analog audio cable 108 to transfer analog audio signals from the analog audio output signal interface 116 of the media source 102 to the analog audio input signal interface 106 of the media sink 104. The analog audio cable 108 provides a wired communications link for the delivery of analog audio signals from the media source 102 to the media sink 104. Similarly, the conventional analog media delivery system 100 uses an analog video cable 114 to transfer analog video signals from the analog video output signal interface 110 of the media source 102 to the analog video input signal interface 112 of the media sink 104. The analog video cable 108 provides a wired communications link for the delivery of analog video signals from the media source 102 to the media sink 104.

Various standard connectivity interfaces have been developed to enable the transfer of analog audio and analog video signals from the media source 102 to the media sink 104. An analog audio connectivity interface typically determines the structure of the analog audio output signal interface 104, the analog audio input signal interface 106, and the audio cable 108. Similarly, an analog video connectivity interface typically determines the structure of the analog video output signal interface 110, the analog video input signal interface 112, and the video cable 108. A specific analog audio and video connectivity interface also determines the format and quality of the analog audio and analog video signals transferred from the media source 102 to the media sink 104. Further, a specific analog audio or video connectivity interface determines the number of interface connections and the number of cables and corresponding number of connectors.

The media source 102 and the media sink 104 may support multiple analog audio and analog video connectivity interfaces. This typically requires the media source 102 and the media sink 104 to include an analog signal interface for each supported standard. Providing compatibility with multiple analog audio and analog video connectivity interfaces increases the flexibility of the media source 102 and the media sink 104.

RCA is a common analog audio connectivity interface typically supported by the media source 102 and the media sink 104. XLR is also a common analog audio connectivity interface typically supported by the media source 102 and the media sink 104. The RCA and XLR analog audio connectivity interfaces each provide analog line-level audio signals. The format and quality of RCA and XLR analog audio signals differ however. Further, the type of connections and cabling required to support RCA and XLR analog audio connectivity interfaces are also distinct.

Composite Video (CVBS) is a common analog video connectivity interface typically supported by the media source 102 and the media sink 104. Other common analog video connectivity interfaces typically supported by the media source 102 and the media sink 104 include, for example, Super-Video (S-Video), YUV, and Red-Green-Blue (RGB). The format and quality of CVBS, S-Video, YUV and RGB analog video signals differ however. Further, the type of connections and cabling required to support CVBS, S-Video, YUV and RGB analog video connectivity interfaces are also distinct.

Despite technical variations among the various standard analog audio and analog video connectivity interfaces, every analog connectivity interface is saddled with several limitations when implemented in conjunction with a wired communications link. For example, the analog audio cable 108 and the analog video cable 114 typically required by a specific analog audio and analog video connectivity interface, respectively, must be of high quality. This causes the analog audio cable 108 and the analog video cable 114 to be very expensive. In turn, the distance between the media sink 102 and the media source 104 is limited by the length of the analog audio cable 108 or the analog video cable 114. Additionally, some analog connectivity standards require multiple connectivity interfaces and cables to accommodate a single wired communications link between the media source 102 and the media sink 104. Further, installation to minimize the exposure of unsightly cables is expensive. These drawbacks are exacerbated by the introduction of multipoint-to-point, point-to-multipoint, or multipoint-to-multipoint connections between one or more media sources 102 and one or more media sinks 104. The introduction of multiple media sources 102 and/or multiple media sinks 104 also requires transmission/reception coordination which typically requires expensive analog signal couplers and/or analog signal splitters.

Therefore, an analog media delivery system that minimizes or eliminates the disadvantages of a wired delivery system is needed. Further, the analog media delivery system should be capable of inexpensively supporting multipoint-to-point, point-to-multipoint, or multipoint-to-multipoint connections.

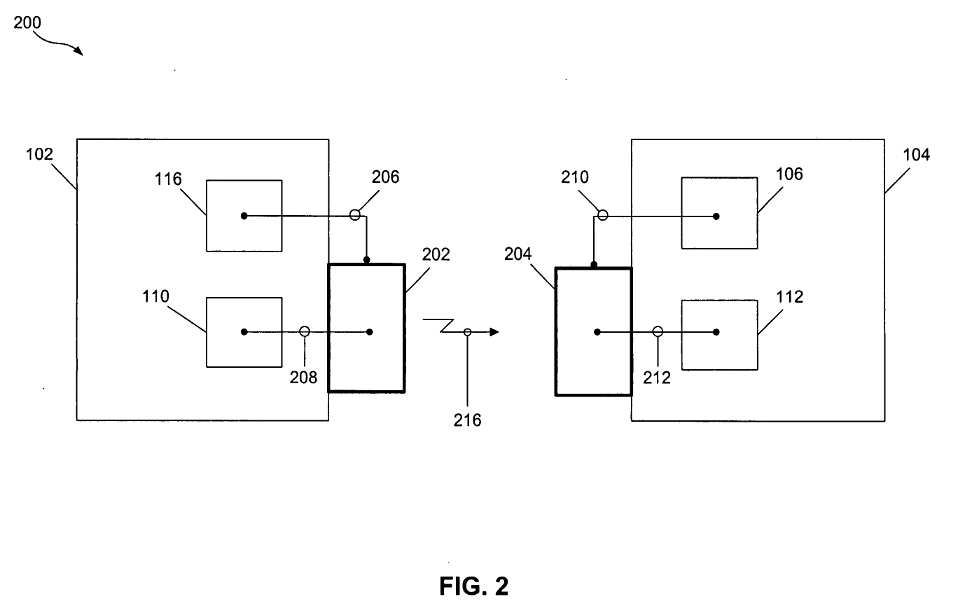

FIG. 2 illustrates an analog media delivery system 200 for transferring analog audio and/or analog video signals from the media source 102 to the media sink 104 that eliminates the disadvantages of a wired delivery system. The analog media delivery system 200 is a wireless delivery system. The analog media delivery system 200 includes a wireless transmitter media adapter 202. The wireless transmitter media adapter 202 is connected to the analog audio output signal interface 116 of the media source 102 by an analog audio cable 206. The wireless transmitter media adapter 202 is connected to the analog video output signal interface 110 of the media source 102 by an analog video cable 208.

The wireless transmitter media adapter 202 receives analog audio and analog video signals from the media source 102 in respective “native” formats. The wireless transmitter media adapter 202 converts the received analog audio and analog video signals into a format more suitable for wireless transmission. Specifically, the received analog audio and analog video signals are converted from their “native” formats to a transmission format and then further processed for transmission over a wireless radio-frequency (RF) channel. The reformatted and processed analog audio and analog video signals are then transmitted as a wireless signal 216 by the wireless transmitter media adapter 202.

As shown in FIG. 2, the analog media delivery system 200 further includes a wireless receiver media adapter 204. The wireless receiver media adapter 204 is connected to the analog audio input signal interface 106 of the media sink 104 by an analog audio cable 210. The wireless receiver media adapter 204 is connected to the analog video input signal interface 112 of the media sink 102 by an analog video cable 212. The wireless receiver media adapter 204 receives the wireless signal 216 from the wireless transmitter media adapter 202. The wireless receiver media adapter 204 converts the reformatted and processed analog audio and analog video signals back to their respective native formats. The native-formatted analog audio and analog video signals are then provided to the media sink 104.

The wireless transmitter media adapter 202 and the wireless receiver media adapter 204 together provide a wireless communications link for the delivery of analog audio and/or analog video signals from the media source 102 to the media sink 104. The wireless communication link provided by the wireless transmitter media adapter 102 and the wireless receiver media adapter 104 no longer requires the media sink 104 to be tethered to the media source 102 by expensive analog audio and analog video cables. In turn, the distance between the media source 102 and the media sink 104 can be increased without the need for additional analog audio and analog video cable.

As will be discussed in more detail herein, the wireless communications link provided by the wireless transmitter media adapter 202 and the wireless receiver media adapter 204 can support raw data rates in excess of 300 Mbps at a bit error rate (BER) of approximately 10⁻⁹ for a received energy per bit to noise power spectral density ratio (E_{B}/N₀) of approximately 3.5 dB. The wireless signal 216 generated by the wireless transmitter media adapter 202 is transmitted over an unlicensed Federal Communications Commission frequency band reserved for Ultra-Wideband (UWB) communication.

The wireless transmitter media adapter 202 and the wireless receiver media adapter 204 can be either internal or external to the media source 102 and the media sink 104, respectively.

Further, as will be discussed in more detail herein, the wireless transmitter media adapter 202 and the wireless receiver media adapter 204 are capable of supporting multipoint-to-point, point-to-multipoint, or multipoint-to-multipoint wireless connections between multiple media sources 102 and multiple media sinks 104 without the need for expensive couplers, splitters or switches.

The wireless transmitter media adapter 202 and the wireless receiver media adapter 204 are compatible with multiple analog connectivity interfaces to accommodate the delivery of analog signals of a variety of formats. Specifically, the wireless transmitter media adapter 202 and the wireless receiver media adapter 204 can deliver, for example, S-Video, CVBS, YUV or RGB formatted analog video signals. Further, the wireless transmitter media adapter 202 and the wireless receiver media adapter 204 can deliver, for example, RCA or XLR formatted analog audio signals.

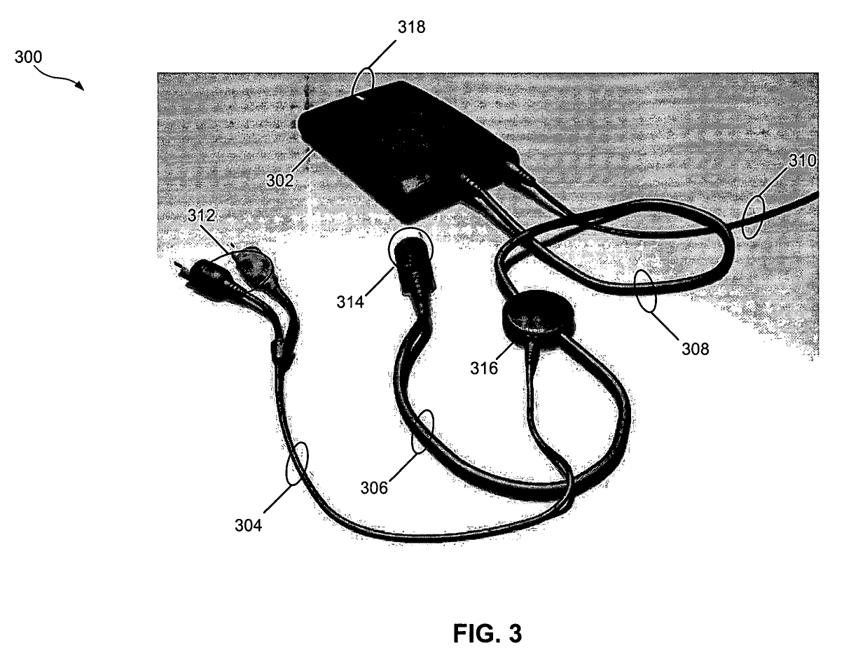

FIG. 3 illustrates a wireless transmitter media adapter (or wireless receiver media adapter) of the present invention as a dongle 300. As shown in FIG. 3, the dongle 300 includes a base unit 302, an analog video cable 306 with corresponding analog video connectors 314, an analog audio cable 304 with corresponding analog audio connectors 312, and a power cable 310. A composite cable interface 316 combines the analog audio cable 304 and the analog video cable 306 onto a composite cable 308. The composite cable 308 is structured to accommodate the analog audio cable 304 and the analog video cable 306 within a single cable.

The composite cable 308 and the power cable 310 are coupled to the base unit 302. The composite cable 308 and the power cable 310 can be either permanently attached to the base unit 302 or can be connected via detachable plugs or jacks. The power cable 310 supplies power to the base unit 302. The power cable 310 can draw power from a wall outlet or, alternatively, can draw power from an existing connection on a media source (or media sink). For example, the power cable 310 can be structured to draw power from the Universal Serial Bus (USB) port provided by a media source or a media sink.

The base unit 302 contains a media adapter interface to convert analog audio and analog video signals from respective native formats to a composite transmission format (or to convert analog audio and analog video signals from a composite transmission format back to respective native formats if a wireless transmitter media adapter). The base unit 302 further includes a wireless transmitter for processing and transmitting a wireless signal containing the reformatted analog audio and analog video signals (or a wireless receiver for receiving and processing a wireless signal containing reformatted analog audio and audio video signals if a wireless transmitter media adapter). An LED 318 provides a visual indication of the status of a wireless link between the base unit 302 and a remote base unit.

The base unit 302 can include either an internal antenna or an external antenna for transmitting wireless signals (or receiving wireless signals if a wireless receiver media adapter). Further, the base unit 302 can include an attachment mechanism to enable the base unit 302 to be attached to the media source 102 depicted in FIG. 2 (or the media sink 104 depicted in FIG. 2 if a wireless receiver media adapter).

As shown in FIG. 3, the analog video cable 306 and the corresponding analog video connector 314 are structured in accordance with the S-Video connectivity interface standard. Further, the analog audio cable 304 and the corresponding analog audio connectors 314 are structured according to the RCA line-level connectivity interface standard. The analog video cable 306 and the corresponding analog video connector 314 can be structured according to a variety of connectivity interface standards including, for example, the YUV, RGB, and CVBS formats. Likewise, the analog audio cable 304 and the corresponding analog audio connectors 312 can be structured according to a variety of connectivity interface standards including, for example, the XLR line-level format.

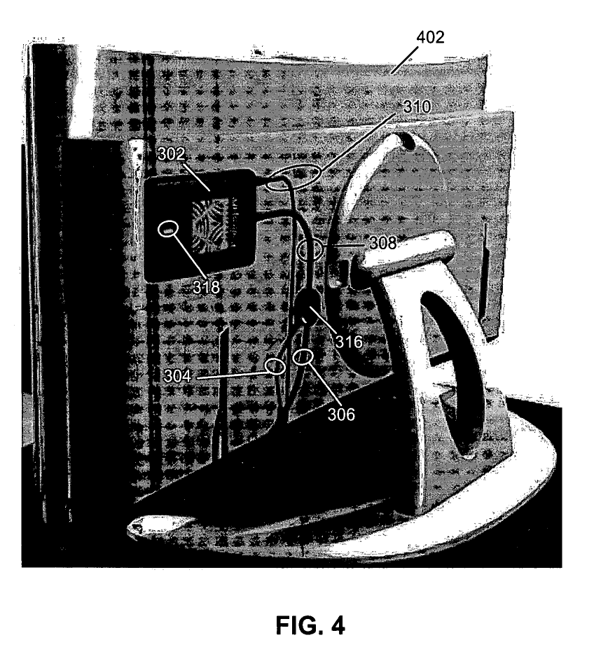

FIG. 4 illustrates the base unit 302 of the dongle 300 attached to a display device 402. The base unit 302 is mounted to the display device 402 by using a pre-existing holder or socket formed on the plastic molding of the display device 402. Alternatively, the base unit 302 can include other attachment mechanisms including, for example, tape, Velcro®, or a hook, to attach to a media sink 104 (or media source 102). Further, the base unit 302 can include a metal or plastic formation built onto the base unit 302 that is designed to “mate” with an equivalent connector located on the media sink 104 (or media source 102).

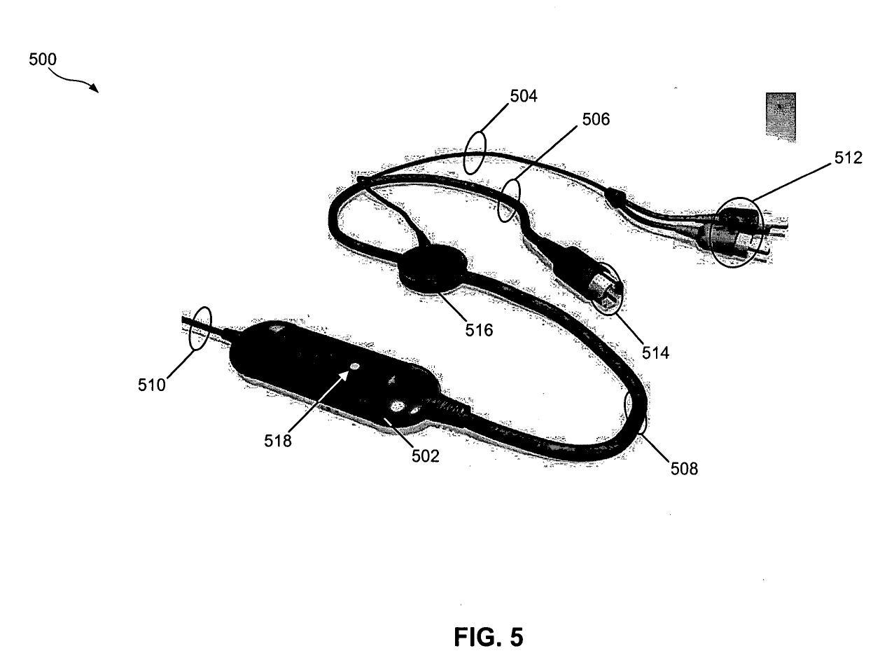

FIG. 5 illustrates a wireless transmitter media adapter (or wireless receiver media adapter) of the present invention as a dongle 500. The dongle 500 is an alternative design of the dongle 300 depicted in FIG. 3. As shown in FIG. 5, the dongle 500 includes a base unit 502, an analog audio cable 504 with corresponding analog audio connectors 512, an analog video cable 506 with a corresponding analog video connector 514, and a power cable 510. A composite cable interface 516 combines the analog audio cable 504 and the analog video cable 506 onto a composite cable 508. The composite cable 508 is structured to accommodate the analog audio cable 504 and the analog video cable 506 within a single cable.

The composite cable 508 and the power cable 510 are coupled to the base unit 502. As further shown in FIG. 5, the composite cable 508 and the power cable 510 are attached to opposite sides of the base unit 502. The composite cable 508 and the power cable 510 can be either permanently attached to the base unit 502 or can be connected via detachable plugs or jacks. The power cable 510 supplies power to the base unit 502. The power cable 510 can draw power from a wall outlet or, alternatively, can draw power from an existing connection on a media source (or media sink). For example, the power cable 510 can be structured to draw power from the Universal Serial Bus (USB) port provided by a media source or a media sink.

The base unit 502 contains a media adapter interface to convert analog audio and analog video signals from respective native formats to a composite transmission format (or to convert analog audio and analog video signals from a composite transmission format back to respective native formats if a wireless transmitter media adapter). The base unit 502 further includes a wireless transmitter for processing and transmitting a wireless signal containing the reformatted analog audio and analog video signals (or a wireless receiver for receiving and processing a wireless signal containing reformatted analog audio and audio video signals if a wireless transmitter media adapter). An LED 518 provides a visual indication of the status of a wireless link between the base unit 502 and a remote base unit.

The base unit 502 can include either an internal antenna or an external antenna for transmitting wireless signals (or receiving wireless signals if a wireless receiver media adapter). Further, the base unit 502 can include an attachment mechanism to enable the base unit 502 to be attached to the media source 102 depicted in FIG. 2 (or the media sink 104 depicted in FIG. 2 if a wireless receiver media adapter).

As shown in FIG. 5, the analog video cable 506 and the corresponding analog video connector 514 are structured in accordance with the S-Video connectivity interface standard. Further, the analog audio cable 504 and the corresponding analog audio connectors 514 are structured according to the RCA line-level connectivity interface standard. The analog video cable 506 and the corresponding analog video connector 514 can be structured according to a variety of connectivity interface standards including, for example, the YUV, RGB, and CVBS formats. Likewise, the analog audio cable 504 and the corresponding analog audio connectors 512 can be structured according to a variety of connectivity interface standards including, for example, the XLR line-level format.

Both existing and proposed communication systems have been suggested for use as analog media delivery systems. Such systems include, for example, Bluetooth®, IEEE 802.11a/b/g and 802.15.3a. These systems were designed to accommodate the wireless delivery of generic content. As a result, these systems are often plagued by low data rates, latency due to the use of compression/decompression techniques, and shared access to limited wireless resources. In contrast, the analog media delivery system of the present invention is specifically tailored to the wireless delivery of a specific analog audio and analog video format. Therefore, the analog media delivery system of the present invention provides high data rates, no latency due to compression/decompression techniques, and dedicated reservation of wireless resources. Further characteristics and capabilities of the analog media delivery system of the present invention are explored below.

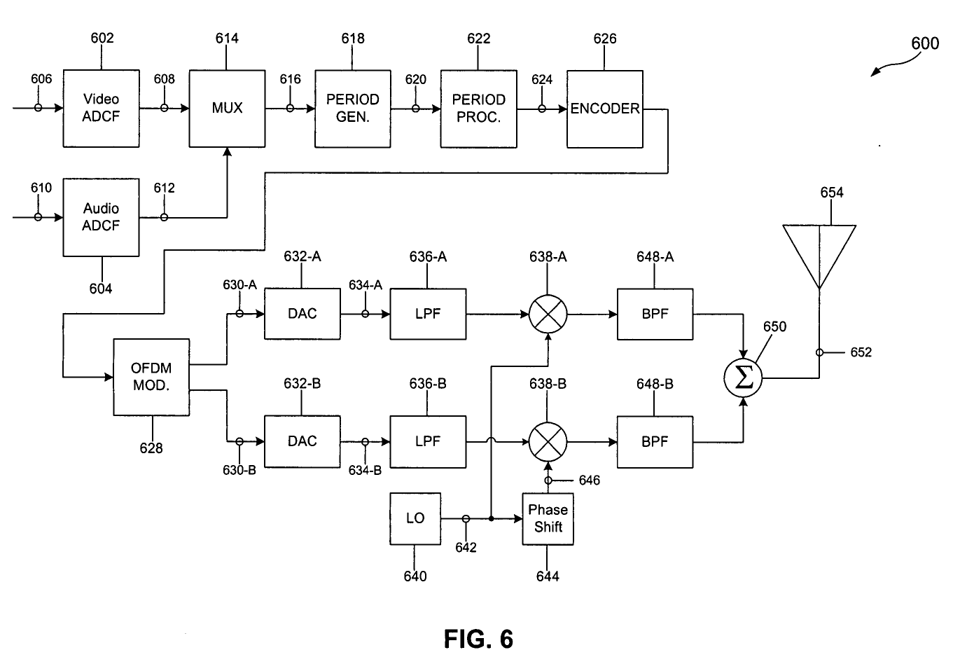

FIG. 6 illustrates a wireless transmitter media adapter 600 of the present invention for use within an analog media delivery system of the present invention. The wireless transmitter media adapter 600 includes an analog video Analog-to-Digital Converter and Formatter (ADCF) 602 and an analog audio ADCF 604. The analog video ADCF 602 receives an analog video signal 606 from a media source (not shown in FIG. 6) in a native analog video format. The analog video ADCF 602 samples and digitizes the received analog video signal 606 and produces an output signal 608. The output signal 608 is a digitized version of the received analog video signal 606 and includes control signals such as, for example, “start of video frame” and “end of video frame.” The control signals associated with the output signal 608 serve to format the output signal 608. The analog audio ADCF 604 receives an analog audio signal 610 from the media source in a native analog audio format. The analog audio ADCF 604 samples and digitizes the received analog audio signal 610 and produces an output signal 612 that is a digitized version of the received analog audio signal 610.

In one aspect of the present invention, the received analog video signal 606 is an S-Video signal and the analog audio signal 610 is an RCA line-level signal. To digitize and format the S-Video signal, the analog video ADCF 602 can include a converter to capture and convert the S-Video signal to International Telecommunication Union (ITU) 656 compliant digital video, an ITU-656 interface, and a demultiplexer. Specifically, the ADCF 602 converts the S-Video signal into a first digital signal that is ITU-656 compliant. The ADCF 602 then demultiplexes the first digital signal to produce a second digital signal. The second digital signal is a digitized analog video signal but is no longer ITU-656 compliant after demultiplexing. To digitize and format the RCA line-level signal, the analog audio ADCF 604 can include a converter that decodes the RCA line-level signal and outputs the decoded signal over an Integrated Circuit Sound (I2S) interface.

As further illustrated in FIG. 6, the output signals 608 and 612 are multiplexed together by a multiplexer 614. The multiplexer 614 generates a multiplexed output signal 616 that includes digitized analog audio signals and digitized analog video signals received from the media source. The multiplexed output signal 616 also includes control signals used to format the constituent digital signals. Typically, the multiplexed output signal 616 contains high data rate video information and low data rate control and audio information. In one aspect of the invention, the multiplexed output signal 616 has a raw data rate of approximately 300 Mbps to accommodate digitized S-video and RCA line-level audio signals, as well as associated control information.

The wireless transmitter media adapter 600 further includes a period generator 618. The period generator 618 formats the multiplexed output signal 616 according to a transmission format. The transmission format can be a composite digital signal format used to format audio and video media. In one aspect of the present invention, the period generator 618 formats the multiplexed output signal 616 according to the High-Definition Multimedia Interface (HDMI) standard. Under this scenario, the period generator 618 produces an HDMI-formatted output signal 620. Specifically, the period generator 618 combines and formats the digitized analog audio and digitized analog video signals (and corresponding control signals) into HDMI frames. Each HDMI frame contains data for reproducing multiple lines of a video display or picture with accompanying audio.

The HDMI signaling format includes three “period” types. A video data period contains video reproduction information. A data island period contains audio reproduction information or control information. A control period contains only control information. The information rate of a video data period is greater than the information rate of a data island period and the information rate of a control period. Specifically, the information rate of a video data period is approximately twice the information rate of a data island period and approximately four times the information rate of a control period.

To improve the BER performance of the wireless transmitter media adapter 600, a period processor 622 introduces training data or sequences into the HDMI-formatted output signal 620. Specifically, the period processor 622 receives the HDMI-formatted output signal 620 from the period generator 618 and generates a re-formatted HDMI output signal 624 containing training data. The introduced training data are bit sequences known to both the wireless transmitter media adapter 600 and a corresponding remote receiver.

The training data introduced by the period processor 622 is used to compensate for channel impairments such as, for example, frequency selective fading and attenuation due to RF obstacles. The training data is also used to compensate for RF impairments including, for example, transmitter and receiver Local Oscillator (LO) frequency offsets and in-phase (I) channel/quadrature-phase (Q) channel imbalances. Further, the training data is used to compensate for mixed-signal impairments such as, for example, sampling clock errors and timing offsets. The power levels associated with the training data can also be measured to maintain a desired transmit power level. These power levels can also be used to set internal transmitter and receiver power levels to fully exploit the available dynamic range of the transmitter and/or receiver.

The period processor 622 introduces training data during the Horizontal Blanking Intervals (HBI) and Vertical Blanking Intervals (VBI) of the HDMI-formatted output signal 620. Typically, the information rate of the HDMI-formatted output signal 620 is greatly reduced during VBI and HBI since video information is not transmitted. Long training sequences are introduced by the period processor 622 by reformatting the information transmitted during the VBI and the HBI.

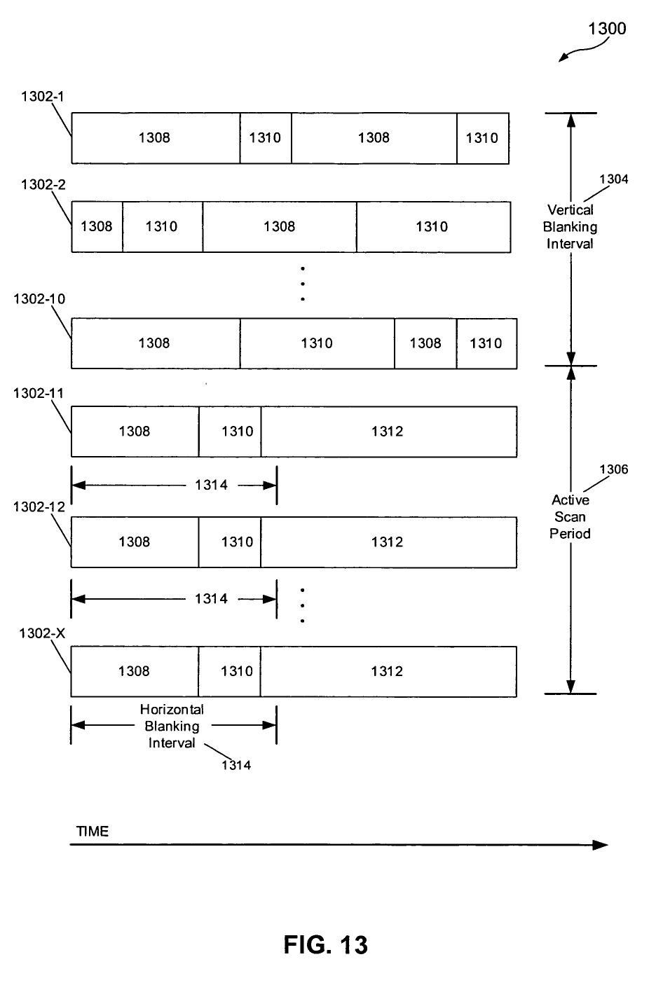

FIG. 13 illustrates the insertion of training sequences within a portion of an HDMI frame 1300 according to the present invention. As shown in FIG. 13, the HDMI frame 1300 includes a number of lines 1302-1 through 1302-X. The lines 1302-1 through 1302-X are transmitted sequentially. The lines 1302-1 through 1302-10 are transmitted during a vertical blanking interval 1304. The lines 1302-11 through 1302-X are transmitted during an active scan period 1306. Lines transmitted during the active scan period 1306 can contain control periods 1308, data island periods 1310, and video data periods 1312. These lines contain active video information within the video data periods 1312 and are considered active scan lines. Lines transmitted during the vertical blanking interval 1304 do not contain video data periods 1312. Horizontal blanking intervals 1314 begin each active scan line during the active scan period 1306. Video data periods 1312 are not transmitted during the horizontal blanking intervals 1314.

As shown in FIG. 13, each line can contain multiple control periods 1308 and data island periods 1310. The positioning and duration of control periods 1308 and data island periods 1310 can vary with each line. Further, the positioning and length of control periods 1308 and data island periods 1310 in one line is not dependent on the positioning and length of control periods 1308 and data island periods 1310 in another line.

As previously mentioned, the transmission information rate of the data island periods 1310 is approximately one-half the transmission information rate of the video data periods 1312. Further, the transmission information rate of the control periods 1308 is approximately one-fourth the transmission information rate of the video data periods 1312. To introduce training data with minimal system complexity, the period processor 622 reformats the HDMI frame 1300 and transmits the control periods 1308 and the data island periods 1310 at the transmission information rate of the video data periods 1312. Specifically, the period processor 622 speeds up the transmission information rate of the control periods 1308 such that the control periods 1308 are transmitted in approximately one-quarter of the time typically required to transmit a control period 1308. Similarly, the period processor 622 speeds up the transmission information rate of the data island periods 1310 such that the data island periods 1310 are transmitted in approximately one-half of the time typically required to transmit a data island period 1310. The ability of the period processor 622 to transmit the control periods 1308 and the data island periods 1310 at a faster information rate “frees up” time or bit intervals for the insertion of training data.

To insert training data, the period processor 622 reformats a line or a portion of a line such that the original information is packed into a reformatted data block. That is, the information contained within the control periods 1308, data island periods 1310 or video data periods 1312 of a line or portion of a line are repacked and reformatted into reformatted data blocks. The reformatted data blocks can contain overhead information and header information to differentiate the different types of information contained therein. Further, each line can contain multiple reformatted data blocks. Together, the reformatted data blocks of a line contain the same information as the original control periods 1308, data island periods 1310 or video data periods 1312 of a line. The reformatted data blocks, however, convey this information in less time. The freed up time of each line or portion of a line can therefore accommodate training data.

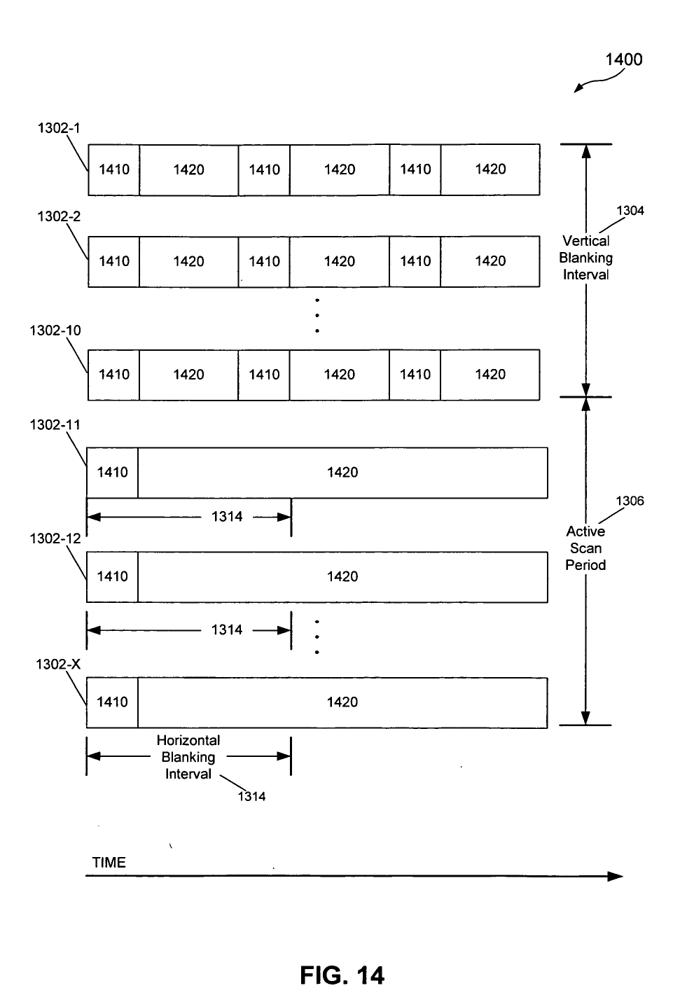

FIG. 14 illustrates the placement of training sequences or data within a portion of a reformatted HDMI frame 1400 according to the present invention. The reformatted HDMI frame 1400 is based on the HDMI frame 1300 depicted in FIG. 13. Reformatted data blocks 1420 contain information from control periods 1308, data island periods 1310 or video data periods 1312. The reformatted data blocks 1420 contain overhead and header information to distinguish the type of information contained. The reformatted data blocks 1420 within the vertical blanking interval 1304 can contain one or more whole or partial control periods 1308 or data island periods 1310. Training blocks 1410 contain training data inserted by the period processor 622 into available bit intervals of each line.

In one aspect of the present invention, the period processor 622 inserts the training blocks 1410 at fixed locations within each line. For example, the period processor 622 can place training blocks 1410 at the same fixed locations within the lines 1302-1 through 1302-10. The period processor 622 can also place training blocks 1410 at the same fixed location within the lines 1302-11 through 1302-X. Placing the training blocks 1410 at fixed locations determines the location or placement of reformatted data blocks 1420. Consequently, a level of predictability within the reformatted HDMI frame 1400 can be conveyed. This enables a receiver to more easily locate the training blocks 1410 contained within the reformatted HDMI frame 1400 and guarantees certain performance measures.

FIG. 14 shows that long training sequences can be introduced by the training data insertion method of the present invention. Specifically, after accounting for overhead needed to distinguish between period types and training data, the insertion method of the present invention enables approximately one-half of the VBI and HBI to be used for the transmission of training sequences. In this way, the insertion method of the present invention provides a dynamic introduction of both channel estimation and power level setting updates on a line-by-line basis without reducing throughput.

In another aspect of the present invention, the period processor 622 provides insertion of an extended training sequence when the wireless transmitter media adapter 600 first establishes a wireless link with a corresponding remote receiver. The use of an extended training sequence before the transfer of media content provides an initial high-fidelity impairment estimation and power level setting. Such an extended training interval is not available in standard Carrier Sense Multiple-Access/Collision Avoidance (CSMA/CA) schemes such as, for example, IEEE 802.11 or IEEE 802.15.3a.

Referring back to FIG. 6, the wireless transmitter media adapter 600 further includes a channel encoder 626. The channel encoder 626 encodes the re-formatted HDMI output signal 624 according to a forward error correction (FEC) code. The channel encoder 626 adds coding overhead information to the re-formatted HDMI output signal 624. The coding overhead information is used by a corresponding remote receiver to foster the reception of a wireless signal with a low symbol error rate (SER).

In one aspect of the present invention, a low-density parity check (LDPC) code is used as the FEC code. Specifically, an LDPC code having a length (L) equal to 4096 and a coding rate (R) equal to 0.8 is used to encode the reformatted HDMI output signal 624. When supporting S-Video, the overhead information added to the re-formatted HDMI output signal 624 increases the symbol rate to approximately 375 Msps.

An Orthogonal Frequency Division Multiplexing (OFDM) modulator 628 is coupled to the output of the channel encoder 626. The OFDM modulator 628 modulates the output of the channel encoder 626 and produces a complex signal (illustrated in FIG. 6 as complex signal 630-A and 630-B). The OFDM modulator 628 also inserts pilot tones used by a corresponding receiver for phase and sampling clock tracking and null tones to reduce the processing requirements of the wireless transmitter media adapter 600. Further, the OFDM modulator performs spreading and padding as necessary to match input symbol and output symbol rates. The complex signals 630-A and 630-B are coupled to digital-to-analog converters (DACs) 632-A and 632-B, respectively. The DAC 632-A converts the complex signal 630-A from a digital signal to a corresponding analog signal 634-A. Similarly, the DAC 632-B converts the complex signal 630-B from a digital signal to a corresponding analog signal 634-B.

The analog signals 634-A and 634-B are passed to low pass filters (LPFs) 636-A and 636-B, respectively. The LPFs 636-A and 636-B suppress distortion introduced by the corresponding DACs 632-A and 632-B. The outputs of the LPFs 636-A and 636-B are coupled to mixers 638-A and 638-B, respectively. The mixer 638-A receives a carrier signal 642 from an LO 640. The carrier signal 642 is typically a relatively high frequency sinusoidal waveform. The mixer 638-A up-converts the analog signal 634-A to a frequency of the carrier signal 642. Specifically, the mixer 638-A produces a frequency-translated version of the analog signal 634-A.

A phase shifter 644 receives the carrier signal 642. The phase shifter 644 shifts the phase of the carrier signal 642 to produce a phase shifted carrier signal 646. Typically, the phase shifter 644 shifts the phase of the carrier signal by ±90 degrees. The mixer 638-B receives the phase shifted carrier signal 646 from the phase shifter 644. The mixer 638-B up-converts the analog signal 634-B to a frequency of the phase shifted carrier signal 646. Specifically, the mixer 638-B produces a frequency-translated version of the analog signal 634-B.

The output of the mixer 638-A is fed to a bandpass filter (BPF) 648-A. The BPF 648-A reduces unwanted harmonics and noise from the up-conversion process. Similarly, the output of the mixer 638-B is fed to a BPF 648-B which also reduces unwanted harmonics and noise from the up-conversion of the analog signal 534-B. The outputs of the BPFs 648-A and 648-B are fed to a summer 650. The summer 650 generates a composite up-converted signal 652. The composite up-converted signal 652 is fed to an antenna 654 for wireless transmission. A power amplifier (PA) can be used to amplify the composite up-converted signal 652 before transmission by the antenna 654. The antenna 654 can be an omni-directional antenna or can be a directional antenna. Alternatively, the antenna 654 can be implemented as a set of antennas to provide transmitter spatial diversity.

The mixers 638-A and 638-B, in conjunction with the DACs 632-A and 632-B, can form an I/Q modulator. That is, the mixers 638-A and 638-B can provide up-converted I and Q modulated data channels. In one aspect of the present invention, the mixers 638-A and 638-B up-convert the analog signals 634-A and 634-B to a 0.3 GHz wide frequency channel. The 0.3 GHz channel is selected from the set of frequencies reserved by the FCC for UWB operation (i.e., 3.1-10.6 GHz).

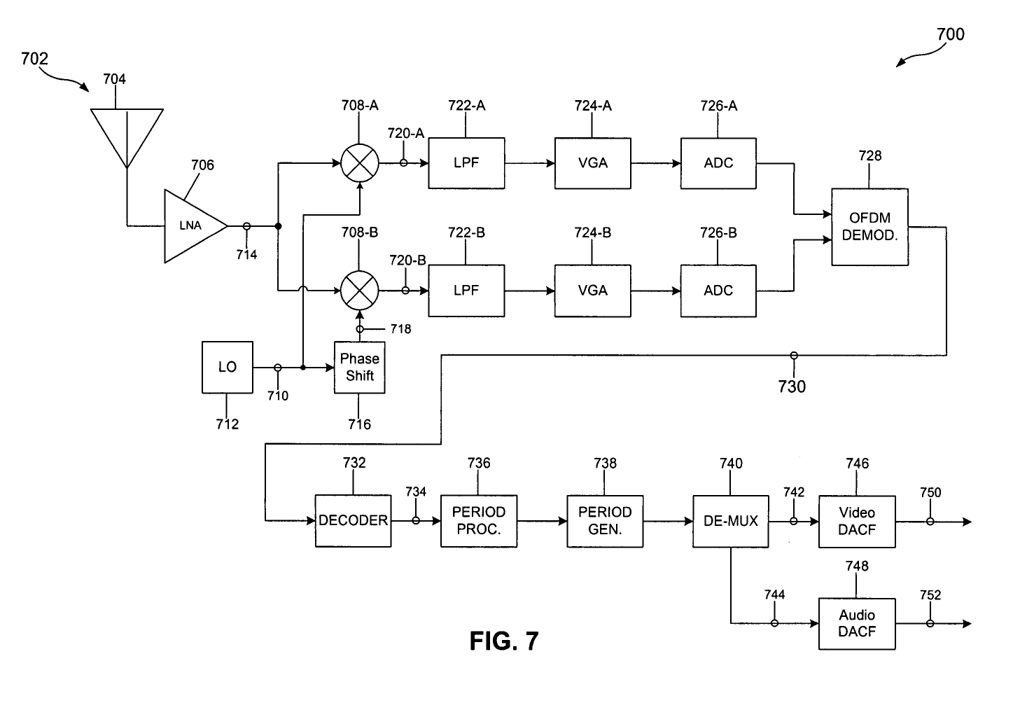

FIG. 7 illustrates a wireless receiver media adapter 700 of the present invention for use within an analog media delivery system of the present invention. Specifically, the wireless receiver media adapter 700 can be paired with the wireless transmitter media adapter 600 depicted in FIG. 6 to provide an end-to-end analog media delivery system of the present invention.

As shown in FIG. 7, the wireless receiver media adapter 700 receives a wireless data signal 702 at an antenna 704. The antenna 704 can be a omni-directional antenna or can be a directional antenna. Alternatively, the antenna 704 can be implemented as a set of antennas to provide receiver spatial diversity. The output of the antenna 704 is fed to a Low Noise Amplifier (LNA) 706. The LNA 706 amplifies the output of the antenna 704 to produce an amplified data signal 714.

The wireless receiver media adapter 700 includes two parallel channels for processing I and Q data contained within the amplified data signal 714. Specifically, the output of the LNA 706 is fed to a mixer 708-A and to a mixer 708-B. The mixer 708-A receives an oscillator signal 710 from a local oscillator (LO) 712. The oscillator signal 710 is a replica of the carrier signal 642 generated by the LO 640 of the wireless transmitter media adapter 600. The mixer 708-A directly down-converts the amplified data signal 714 to a baseband frequency. Specifically, the mixer 708-A produces an in-phase data signal 720-A. The in-phase data signal 720-A is a frequency-translated version of the amplified data signal 714.

A phase shifter 716 receives the oscillator signal 710. The phase shifter 716 shifts the phase of the oscillator signal 710 to produce a phase shifted oscillator signal 718. Typically, the phase shifter 716 shifts the phase of the oscillator signal 710 by ±90 degrees. The mixer 708-B receives the phase shifted oscillator signal 718 from the phase shifter 716. The mixer 708-B directly down-converts the amplified data signal 714 to a baseband frequency. Specifically, the mixer 708-B produces a quadrature-phase data signal 720-B. The quadrature-phase data signal 720-B is a frequency-translated version of the amplified data signal 714.

The in-phase data signal 720-A is fed to a LPF 722-A and a variable gain amplifier (VGA) 724-A. The LPF 722-A isolates the portion of the in-phase data signal 720-A containing data generated by the wireless transmitter media adapter 600. The VGA 724-A amplifies the filtered output of the LPF 722-A. Similarly, the quadrature-phase data signal 720-B is fed to a LPF 722-B and a VGA 724-B. The LPF 722-B isolates the portion of the quadrature-phase data signal 720-B containing data generated by the wireless transmitter media adapter 600 and the VGA 724-B amplifies the filtered output of the LPF 722-B.

As further shown in FIG. 7, the outputs of the VGAs 724-A and 724-B are fed to analog-to-digital converters (ADCs) 726-A and 726-B, respectively. The ADC 726-A converts the in-phase data signal 720-A from an analog signal to a digital signal. The converted in-phase data signal 720-A is then fed to an OFDM demodulator processor 728. The ADC 726-B converts the quadrature-phase data signal 720-B from an analog signal to a digital signal. The converted quadrature-phase data signal 720-B is then fed to the OFDM demodulator processor 728.

The OFDM demodulator processor 728 performs operations such as, for example, synchronization, equalization and channel estimation. Training information, introduced by the period processor 622, is removed from the input to the OFDM demodulator processor 728 and is used for dynamic channel estimation and power level adjustment. Further, the OFDM demodulator processor 728 de-spreads, de-pads and demodulates in-phase data contained within the in-phase data signal 720-A and quadrature-phase data contained within the quadrature-phase data signal 720-B to produce a stream of demodulated symbols 730. The demodulated symbols 730 are fed to a channel decoder 732. The channel decoder 732 decodes the demodulated symbols 730 in accordance with the channel encoding scheme employed by the channel encoder 626 of the wireless transmitter media adapter 600. Accordingly, the channel decoder 732 produces a composite digital output stream 734.

The composite digital output stream 734 contains audio and video data as well as control information. The composite digital output stream 734 is formatted according to a transmission format. In one aspect of the present invention, the composite digital output stream 734 is formatted according to the HDMI format as a result of the format conversion process implemented by the wireless transmitter media adapter 600. Specifically, the format of the composite digital output stream 734 mimics the format of the reformatted HDMI output signal 624 produced by the period processor 622.

As further shown in FIG. 7, the composite digital output stream 734 is fed to a period processor 736. The period processor 736 reformats the composite digital output stream 734 into a standard HDMI format. Specifically, the output of the period processor 736 is a digital output signal formatted in the same manner as the HDMI-formatted output signal 620.

A period generator 738 removes the HDMI formatting from the output of the period processor 736. Specifically, the format of the output of the period generator 738 mimics the formatting of the multiplexed output signal 616 of the wireless transmitter media adapter 600, although variation between period placement on a given line is possible. In this way, the output of the period processor is converted from a transmission format back to a multiplexed signal. The output of the period generator 738 therefore contains digitized analog audio data and digitized analog video data (as well as control information) in a multiplexed digital format.

The output of the period generator 738 is fed to a demultiplexer 740. The demultiplexer 740 demultiplexes the composite output of the period generator 738 and generates a digitized analog video signal 742 and a digitized analog audio signal 744. The digitized analog video signal 742 is fed to an analog video Digital-to-Analog Converter and Formatter (DACF) 746. The analog video DACF 746 converts the digitized analog video signal 742 to an analog video signal 750. Further, the analog video DACF 746 formats the analog video signal 750 in accordance with the formatting of the analog video signal 606 received by the analog video ADCF 602. In this way, the analog video signal 750 is completely converted back into its original native format (i.e., the format provide by the media source) and is identical to the analog video signal 606. The analog video signal 750 is provided to a media sink (not shown in FIG. 7) for reproduction, display, or recording.

The digitized analog audio signal 744 is fed to an analog audio DACF 748. The analog audio DACF 748 converts the digitized analog audio signal 744 to an analog audio signal 752. Further, the analog audio DACF 748 formats the analog audio signal 752 in accordance with the formatting of the analog audio signal 610 received by the analog audio ADCF 604. In this way, the analog audio signal 752 is converted back into its original native format (i.e., the format provide by the media source) and is identical to the analog audio signal 610. The analog audio signal 752 is provided to a media sink (not shown in FIG. 7) for reproduction, display, or recording.

In one aspect of the present invention, the analog video DACF 746 converts the digitized analog video signal 742 to an S-Video signal and the analog audio DACF 748 converts the digitized analog audio signal 744 to an RCA-line level signal. To do so, the analog video DACF 746 can include a multiplexer and an ITU-656 interface to generate ITU-656 compliant digital video, and a converter that de-formats the ITU-656 digital video to regenerate the S-Video signal. Specifically, the DACF 746 multiplexes the digitized analog video signal 742 to produce a first digital signal that is ITU-656 compliant. The first digital signal is subsequently de-formatted by the converter to produce a regenerated S-video signal. To convert the digitized analog audio signal 744, the analog audio DACF 748 can include an I2S interface and an audio encoder to receive the digitized analog audio signal 744 and to regenerate the RCA line-level signal.

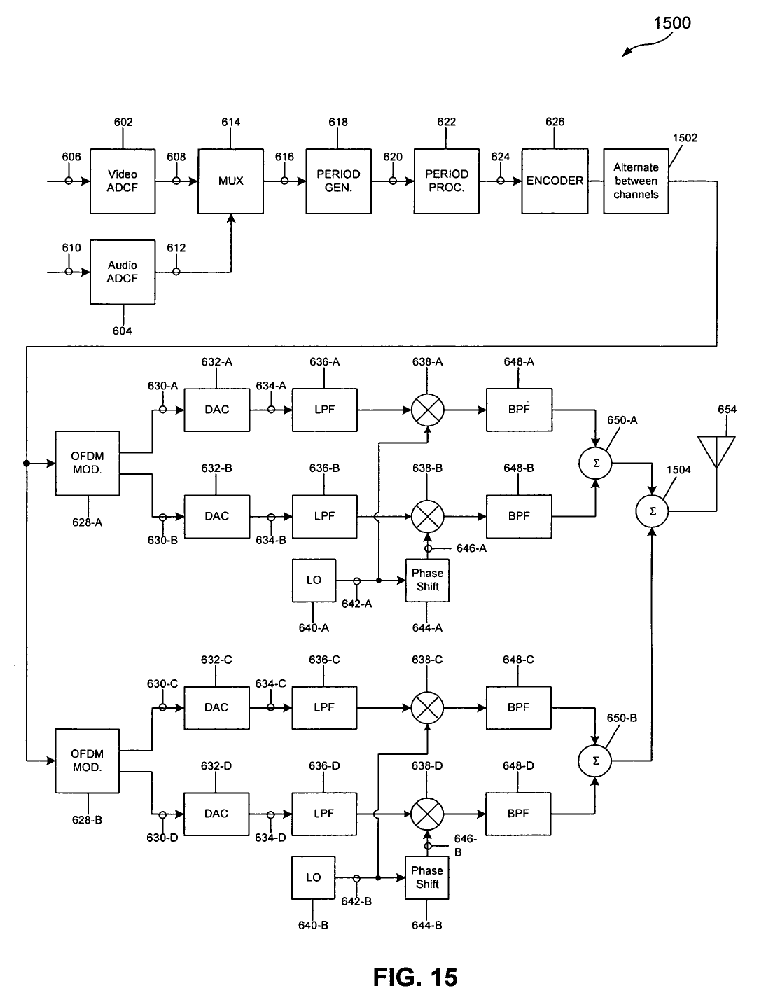

In one aspect of the present invention, the wireless data link provided by the present invention occupies two different RF channels. FIG. 15 illustrates a wireless transmitter media adapter 1500 that alternately sends encoded data (i.e., the output of the encoder 626) along one of two signal processing paths for transmission over two different RF channels. As shown in FIG. 15, the wireless transmitter media adapter has two signal processing paths. A first signal processing path includes the elements between OFDM modulator 628-A and summer 650-A. A second signal processing path includes the elements between OFDM modulator 628-B and summer 650-B. Encoded data from the encoder 626 is alternately sent to one of the two signal processing paths for transmission over two different RF channels by logic 1502. For clarification, FIG. 15 is labeled to indicate that functional elements and signals having like reference numbers (e.g., the DAC 632-B and the DAC 632-D) perform substantially the same operations. Some of the differences in operation of the wireless transmitter media adapter 600 and the wireless transmitter media 1500 are discussed herein.

As shown in FIG. 15, each signal processing path includes an OFDM modulator (i.e., the OFDM modulators 628-A and 628-B) coupled to the logic 1502. The OFDM modulators 628-A and 628-B perform spreading and padding as necessary to match the input symbol rate from the encoder 626 with the two channel output symbol rates (i.e., the outputs of the summers 650-A and 650-B). The outputs of the summers 650-A and 650-B are fed to a summer 1504 to form a combined output signal. This combined output signal is fed to the antenna 654 for wireless transmission. The combined output signal may be amplified prior to transmission.

By providing two signal processing paths, the wireless transmitter media adapter 1500 enables the output signal to use two RF channels. In one aspect of the present invention, the first and second signal processing paths up-convert respective output signals to two adjacent RF channels. For example, a first RF channel of approximately 3.3 to 3.6 GHz and a second RF channel of approximately 3.6 to 3.9 GHz are used to provide the wireless data link.

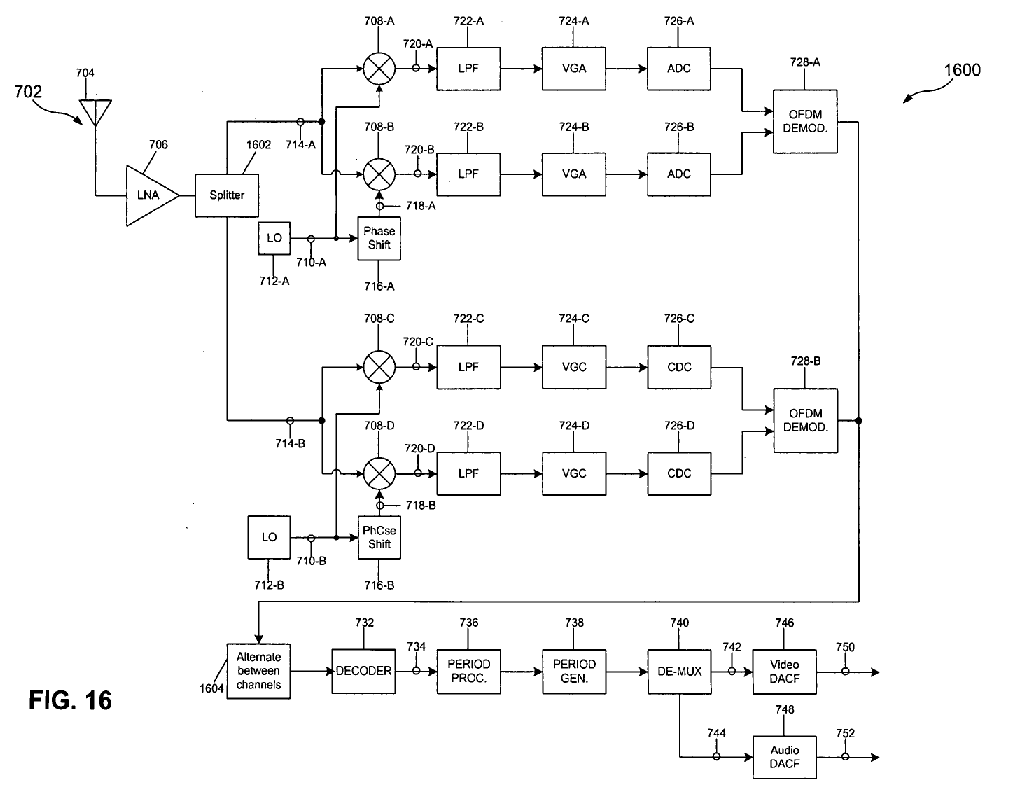

FIG. 16 illustrates a wireless receiver media adapter 1600 that provides a received signal (i.e., the output of the LNA 706) to two signal processing paths for the reception of data transmitted over two different RF channels. A splitter 1602 is used provide the received signal to each signal processing path in parallel. A first signal processing path of the wireless receiver media adapter 1600 includes those elements between the splitter 1602 and OFDM demodulator 728-A. A second signal processing path includes those elements between the splitter 1602 and OFDM demodulator 728-B. For clarification, FIG. 16 is labeled to indicate that functional elements and signals having like reference numbers (e.g., the ADC 726-B and the ADC 726-D) perform substantially the same operations. Some of the differences in operation of the wireless transmitter media adapter 600 and the wireless transmitter media 1500 are discussed herein.

As shown in FIG. 16, the outputs of the OFDM demodulators 728-A and 728-B are fed to logic 1604. The logic 1604 forms a single data stream by alternating between the two streams of demodulated data symbols provided by the OFDM demodulators 728-A and 728-B. The output of the logic 1604 is fed to the decoder 732. The two signal processing channels of the wireless receiver media adapter 1600 compliment the two signal processing channels of the wireless transmitter media adapter 1500. In this way, the wireless receiver media adapter 1600 receives and processes data provided over two dedicated wireless links in accordance with two channel operation of the present invention.

The wireless transmitter media adapter 600/1500 and the wireless receiver media adapter 700/1600 provide a connection interface and a delivery system for the wireless transfer of analog video and analog audio signals from a media source to a media sink. The wireless connection interface and delivery system of the present invention supports equivalent digital data rates associated with a conventional analog audio-video connectivity interface (i.e., an analog video and analog audio cable). Specifically, the wireless interface and delivery system of the present invention provides a low-power received signal having a very low BER required by video display media sinks (typically BER<10⁻⁹). The wireless interface and delivery system of the present invention can provides a 300 Mbps signal having a BER<10⁻⁹. Further, the wireless interface and delivery system of the present invention provides this high quality signal with very low latency since the wireless transmitter media adapter 600 does not compress (and the transmitter receiver media adapter 700 does not decompress) the analog audio and analog video data received from the media source.

The wireless interface and delivery system of the present invention provides an end-to-end transfer solution that exceeds the performance capabilities of other existing or proposed transfer systems such as, for example, EEE 802.11a/b/g or EEE 802.15.3a. The IEEE 802.15.3a standard uses a convolutional code with constraint length K=7 as an FEC code. The LDPC code employed by the wireless transmitter media adapter 600/1500 and the wireless receiver media adapter 700/1600 provides substantial improvement with respect to error performance. Table 1, below, provides a comparison of the link budget for an OFDM system employed by the present invention using the coding scheme of IEEE 802.15.3a and the OFDM system and coding scheme employed by the present invention. The coding scheme of IEEE 802.15.3a has a coding rate of R=0.75 while the coding scheme of the present invention has a coding rate of R=0.8. Further, the coding scheme of IEEE 802.15.3a uses Viterbi decoding. Table 1 provides an equivalent comparison of the different coding schemes. That is, Table 1 provides a comparison based on the same operating conditions (e.g., equivalent data rate, transmit power level, received power level, two channel operation, etc.).

TABLE 1
Link Budget for an OFDM system of the present invention
using the IEEE coding scheme 802.15.3a vs. the OFDM system
and LDPC coding scheme of the present invention.

| | | | OFDM/Conv. Code | |
|---|---|---|---|---|
| | | | with Viterbi | |
| | OFDM/LDPC | | Decoding | |
| Parameter | Value | Unit | Value | Unit |
| Throughput (Rb) | 300 | Mbps | 300 | Mbps |
| Average Transmit Power | −13.5 | dBm | −13.5 | dBm |
| Tx antenna gain (Gt) | 0.0 | dB | 0.0 | dB |
| Geometric center | 3.6 | GHz | 3.6 | GHz |
| frequency (Fc) | | | | |
| Path loss at 1 meter | 43.6 | dB | 43.6 | dB |
| (L1 = 20Log(4PI*Fc/c)) | | | | |
| Path loss at 5 meters | 14.0 | dB | 14.0 | dB |
| (L2) | | | | |
| Rx antenna gain (Gr ) | 0.0 | dBi | 0.0 | dBi |
| Rx power at 5 m (Pr = | −71.0 | dBm | −71.0 | dBm |
| Pt + Gt + Gr − | | | | |
| L1 − L2) | | | | |
| Average noise power per | −89.2 | dBm | −89.2 | dBm |
| bit (N = −174 + 10*log(Rb)) | | | | |
| Rx Noise Figure Referred | 5.0 | dB | 5.0 | dB |
| to the Antenna Terminal (Nf) | | | | |
| Average eff. noise power | −84.2 | dBm | −84.2 | dBm |
| per bit (Pn = N + Nf) | | | | |
| Implementation Loss (I) | 2.7 | dB | 2.7 | dB |
| No of Bands | 2 | | 2 | |
| 3 dB Bandwidth per band | 0.3 | GHz | 0.3 | GHz |
| Additional loss due to | 7 | dB | 7 | dB |
| obstacles (O) | | | | |
| E_{B}/N₀ at 5 m (Pr-Pn-I-O) | 3.5 | dB | 3.5 | dB |

| | | |
|---|---|---|
| BER at 5 m | 7.4E−10 | 4.55E−03 |

As illustrated by Table 1, the OFDM/Convolutional Code with Viterbi Decoding system provides a BER of 4.55E-03 for an energy-per-bit to spectral noise density (E_{B}/N₀) of 3.5 dB. The OFDM/LDPC system of the present invention, however, provides a BER of 7.4E-10 for the same E_{B}/N₀ of 3.5 dB. Therefore, the R=0.8, L=4096 LDPC code can achieve high quality operation with error rates more than a million times lower compared with to the system with a R=0.75, K=7, convolutional code and designed using the maximum FCC allowed transmit power in the 3.3-3.9 GHz band. Overall, the LDPC coding scheme performs 5 dB better than the convolutional coding scheme for a required 10⁻⁹ bit error rate. Further, the LDPC scheme employed by the present invention provides an E_{B}/N₀ that is within 1 dB of the best possible code, as determined by the sphere packing bound, for an error rate of 10^{-9.}

Achieving a low BER with a low E_{B}/N₀ improves the security of the analog media delivery system of the present invention by restricting the area authorized over which a transmitted signal can be detected and/or exploited by a non-user. That is, an eavesdropper must be closer to the analog media delivery system of the present invention to intercept a transmitted signal in comparison to a wireless system that requires a higher E_{B}/N₀ at a receiver to achieve the same BER. Further, the low E_{B}/N₀ provided by the present invention also improves the density of transmitter/receiver pairs that can use a dedicated wireless channel. In turn, the frequency reuse of a given wireless channel is increased.

The wireless interface and delivery system of the present invention also provides a high quality received signal with an acceptable level of noise immunity. Specifically, the present invention provides a point-to-point wireless link having a wide bandwidth for data transfer with no Media Access Control (MAC) information overhead. This approach provides an additional benefit as compared to, for example, an IEEE 802.15.3a system. Specifically, additional RF receiver components required by an IEEE 802.15.3a system, such as a transmit/receive switch to support bi-directional communications, can be eliminated to minimize receiver sensitivity (i.e., the noise figure). For instance, while the IEEE 802.15.3a system noise figure (NF) is approximately 6.6 dB, the present invention reduces the NF by more than 1 dB by including only those RF components needed to implement the physical layer wireless protocol. In one aspect of the present invention, MAC information is carried over a separate wireless channel. The aforementioned benefits of a dedicated, point-to-point wireless data link are therefore maintained with the introduction of a bi-directional management channel.

The wireless interface and delivery system of the present invention also provides a transfer system that is low cost. Specifically, due to the reduced complexity of the MAC, the wireless transmitter media adapter 600/1500 and the wireless receiver media adapter 700/1600 can use a low cost microcontroller to process the MAC channel. The wireless transmitter media adapter 600/1500 and the wireless receiver media adapter 700/1600 also do not require additional components to implement data compression and decompression. Further, the wireless transmitter media adapter 600/1500 and the wireless receiver media adapter 700/1600 minimize required RF components by using direct up-conversion and direct down-conversion techniques, respectively, for passband signaling.

In one aspect of the present invention, the wireless communications link established between a single, adaptively chosen wireless transmitter media adapter-wireless receiver media adapter pair (transmitter/receiver media adapter pair) includes a first wireless channel and a second wireless channel. The first wireless channel is dedicated for the transfer of high data rate analog video and analog audio information from a wireless transmitter media adapter to a wireless receiver media adapter. The second wireless channel is dedicated for the bi-directional exchange of MAC information. The first channel is typically considered “the downstream link” while the second channel is typically considered “the backchannel.” Further, the first channel is located on a first frequency band while the second channel is located on a second frequency band different from the first frequency band.

The use of two wireless channels is particularly useful when a transmitter/receiver media adapter pair is in an area adequately RF-isolated from other transmitter/receiver media adapter pairs. For example, transmitter/receiver media adapter pairs may be sufficiently separated spatially so that pairs do not interfere with one another, may be isolated from one another due to RF propagation obstacles such as walls, or may be isolated from one another due to directional RF propagation achieved using antennas with directionality (i.e., antennas that are not omni-directional).

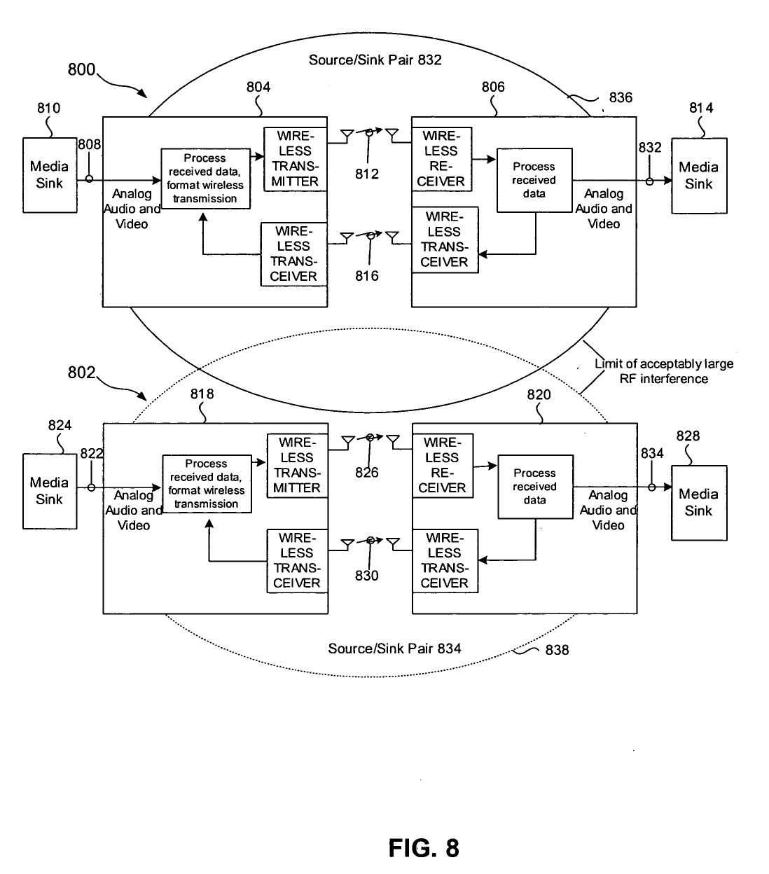

FIG. 8 illustrates a first wireless analog media delivery system 800 and a second wireless analog media delivery system 802 of the present invention. The first and second analog media delivery systems 800 and 802 each use a first wireless channel for the transfer of high data rate analog video and analog audio information and a second wireless channel for the bi-directional exchange of MAC information.

As shown in FIG. 8, the first wireless analog media delivery system 800 includes a wireless transmitter media adapter 804 and a wireless receiver media adapter 806. The wireless transmitter media adapter 804 receives analog audio and video data 808 from a media source 810. The wireless transmitter media adapter 804 processes and formats the received analog audio and video data 808 for wireless transmission. The wireless transmitter media adapter 804 uses a wireless transmitter to transmit the formatted analog audio and video data 808 over a first wireless channel 812.

The wireless receiver media adapter 806 uses a wireless receiver to receive the analog audio and video data 808 transmitted over the first wireless channel 812. The wireless receiver media adapter 806 processes the received analog audio and video data. The processed analog audio and video data 832 is provided to a media sink 814.

The wireless transmitter media adapter 804 and the wireless receiver media adapter 806 each include a wireless transceiver for the bi-directional exchange of MAC information over a second wireless channel 816. The second wireless channel 816 is located on a frequency band different from that of the first wireless channel 812.

As further shown in FIG. 8, the second wireless analog media delivery system 802 includes a wireless transmitter media adapter 818 and a wireless receiver media adapter 820. The wireless transmitter media adapter 818 receives analog audio and video data 822 from a media source 824. The wireless transmitter media adapter 818 processes and formats the received analog audio and video data 822 for wireless transmission. The wireless transmitter media adapter 818 uses a wireless transmitter to transmit the formatted analog audio and video data 822 over a first wireless channel 826.

The wireless receiver media adapter 820 uses a wireless receiver to receive the analog audio and video data 822 transmitted over the first wireless channel 826. The wireless receiver media adapter 820 processes the received analog audio and video data. The processed analog audio and video data 834 is provided to a media sink 828.

The wireless transmitter media adapter 818 and the wireless receiver media adapter 820 each include a wireless transceiver for the bi-directional exchange of MAC information over a second wireless channel 830. The second wireless channel 830 is located on a frequency band different from that of the first wireless channel 826. The first wireless channel 812 and the second wireless channel 816 occupy the same frequency bands as the first wireless channel 826 and the second wireless channel 830, respectively.

The media source 810 and the wireless transmitter media adapter 804 in conjunction with the media sink 814 and the wireless receiver media adapter 806 form a first adaptively-chosen source/sink pair 832. Similarly, the media source 824 and the wireless transmitter media adapter 818 in conjunction with the media sink 828 and the wireless receiver media adapter 820 form a second adaptively-chosen source/sink pair 832. For each pair, there is an area beyond which large RF interference will not significantly impact performance. For the first source/sink pair 832, the outside limit of this area is indicated by reference numeral 836, while for the second source/sink pair 834, the outside limit is indicated by reference numeral 838.

A wireless analog delivery system of the present invention that uses a first wireless channel dedicated for the transfer of high data rate analog video and analog audio information and second wireless channel dedicated for the bi-directional exchange of MAC information offers significant throughput improvements over a system that uses only one wireless channel to exchange data and control information. That is, data throughput is improved by reserving a wide frequency band for the transfer of high data rate analog video and analog audio information in accordance with the present invention.

In contrast, conventional wireless systems that are used for the transfer of high-speed analog audio and video data employ a complex in-band MAC layer to arbitrate channel usage between one or more media sources and one or more media sinks. This MAC layer adds overhead, thereby reducing throughput. In addition, MAC layer signaling requires a much lower data rate than that needed for high-speed analog audio and video data transfer. Therefore, during intervals over which MAC layer signaling is passed, channel bandwidth is wasted.

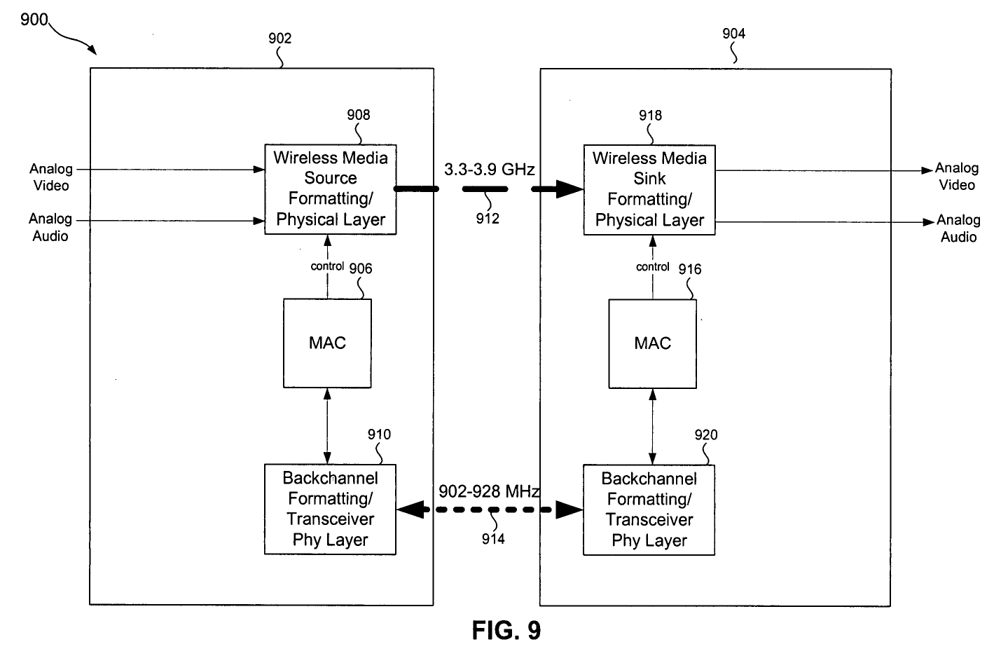

FIG. 9 illustrates in more detail a wireless analog media delivery system 900 of the present invention that uses a first wireless channel for transferring high data rate analog video and analog audio information and a second wireless channel for MAC signaling. As shown in FIG. 9, the wireless analog media system 900 includes a wireless transmitter media adapter 902 and a wireless receiver media adapter 904. The wireless transmitter media adapter 902 receives analog audio and video signals from a media source (not shown in FIG. 9). The wireless transmitter media adapter 902 includes a MAC 906, logic 908, and logic 910. The logic 908 performs media source formatting and physical layer functions for transmitting analog video and audio content over a wireless media channel 912 under the control of the MAC 906. The logic 910 performs backchannel formatting and transceiver physical layer functions for communicating MAC information over a backchannel 914. Information relevant to backchannel protocols is communicated between the MAC 906 and the logic 910.

As further shown in FIG. 9, the wireless receiver media adapter 904 includes a MAC 916, logic 918 and logic 920. The logic 918 performs media sink formatting and physical layer functions for receiving analog video and audio content over the wireless media channel 912 under the control of the MAC 916. The logic 920 performs backchannel formatting and transceiver physical layer functions for communicating MAC information over backchannel 914. Information relevant to backchannel protocols is communicated between the MAC 916 and the logic 920.

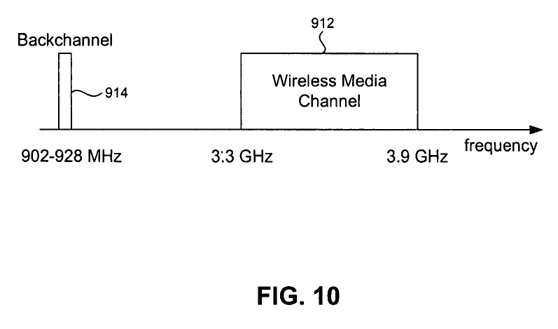

In one aspect of the present invention, the wireless media channel 912 occupies a bandwidth approximately in the range of 3.3 GHz to 3.9 GHz to accommodate two channel operation, while the backchannel 914 occupies a bandwidth approximately in the range of 902-928 MHz. FIG. 10 illustrates this bandwidth allocation scheme.

A wireless analog media delivery system of the present invention that uses OFDM for transmitting signals between a wireless transmitter media adapter and a wireless receiver media adapter can use OFDM windowing and null tones to ensure that the use of a wireless protocol in accordance with the present invention does not interfere with systems such as IEEE 802.11j that operate at or near 4.9 GHz.

In one aspect of the present invention, a bandwidth approximately in the range of 6 GHz to 10.6 GHz is used for wireless transmission of high data rate analog video and analog audio information. This is advantageous in that it avoids interference from users operating under existing or planned communications systems. That is, no high-volume systems have currently been proposed for operation in this band. In another aspect of the present invention, a wireless analog media delivery system of the present invention uses frequency hopping to enable an increase in peak power by more than a factor of two while still meeting FCC transmit power requirements.

In another aspect of the present invention, a wireless analog media delivery system of the present invention that uses OFDM for transmitting signals between a wireless transmitter media adapter and a wireless receiver media adapter can provide streaming audio information to multiple audio speakers simultaneously. According to this aspect of the invention, a media sink includes one or more audio speakers. To continuously provide analog audio signals to each speaker, the analog media delivery system can assign a range of OFDM tones to each speaker. Analog audio information directed to a specific speaker is transported over the assigned range of frequencies. In this way, the present invention can provide streaming analog audio information from a media source to a media sink having multiple audio speakers to implement a surround sound audio scheme.

In one aspect of the present invention, an auto-detect/auto-connect process is carried out over a separate RF channel from that used for the transfer of high data rate analog video and analog audio information. The process determines a pair from a possible set of wireless transmitter media adapters and wireless receiver media adapters for which the channel should be dedicated for a particular time interval. In contrast, prior art systems utilize separate wired connections between each transmitter and receiver or use a complicated MAC for wireless channel contention. Accordingly, the present invention advantageously eliminates the overhead of such a complex MAC, eliminates cables, and eliminates manual user connection of wireless transmitter media adapters and wireless receiver media adapters.

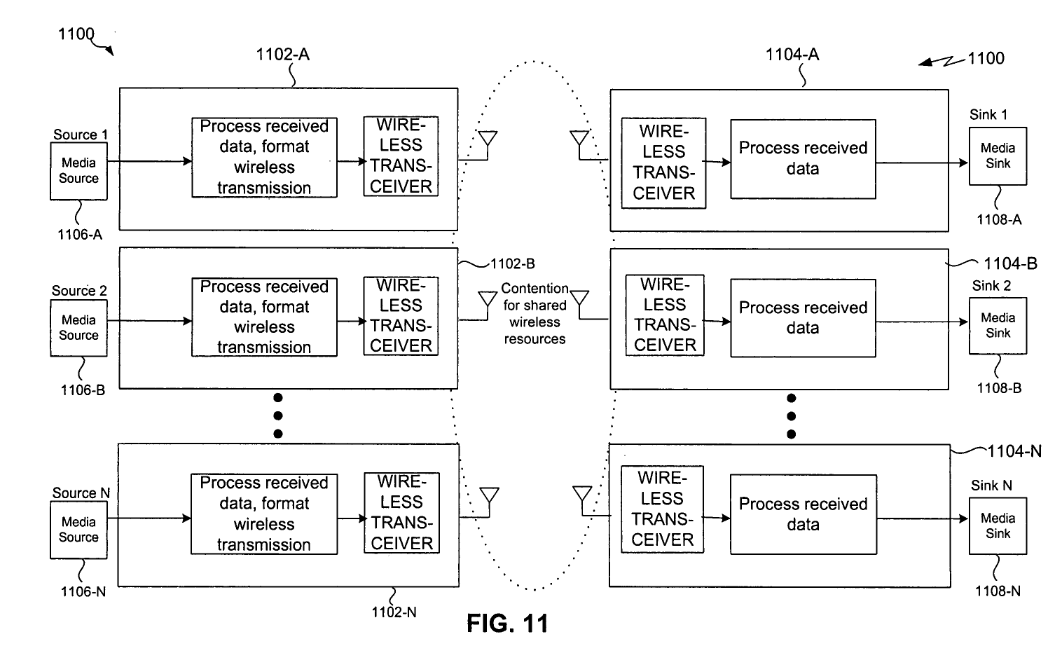

FIG. 11 illustrates a wireless analog media delivery system 1100 of the present invention that includes multiple wireless transmitter media adapters 1102-A through 1102-N and multiple wireless receiver media adapters 1104-A through 1104-N. The wireless transmitter media adapters 1102-A through 1102-N are connected to corresponding media sources 1106-A through 1106-N, respectively. The wireless receiver transmitter media adapters 1104-A through 1104-N are connected to corresponding media sinks 1108-A through 1108-N, respectively.

The wireless transmitter media adapters 1102-A through 1102-N and the wireless receiver media adapters 1104-A through 1104-N must contend for shared wireless resources. As will be described in more detail herein, each of the wireless transmitter media adapters 1102-A through 1102-N and the wireless receiver media adapters 1104-A through 1104-N is configured to perform an auto-detect and auto-connect process that enables efficient sharing of limited wireless resources. Specifically, the auto-detect and auto-connect process of the present invention enables a particular wireless receiver media adapter to determine the wireless transmitter media adapter from which it will receive analog audio and video data. In this way, the auto-detect and auto-connect process of the present invention provides a method for establishing a point-to-point wireless communication link between a wireless transmitter media adapter-wireless receiver media adapter pair.

The auto-detect and auto-connect process of the present invention also enables a particular wireless receiver media adapter to determine the multiple wireless transmitter media adapters from which it will receive analog audio and video data. That is, the auto-detect and auto-connect process of the present invention allows the wireless analog media delivery system 1100 to support multipoint-to-point wireless communication. Further, the auto-detect and auto-connect process of the present invention enables a particular wireless transmitter media adapter to determine the multiple wireless receiver media adapters to which it will transfer analog audio and video data. That is, the auto-detect and auto-connect process of the present invention allows the wireless analog media delivery system 1100 to support multipoint-to-point wireless communication.

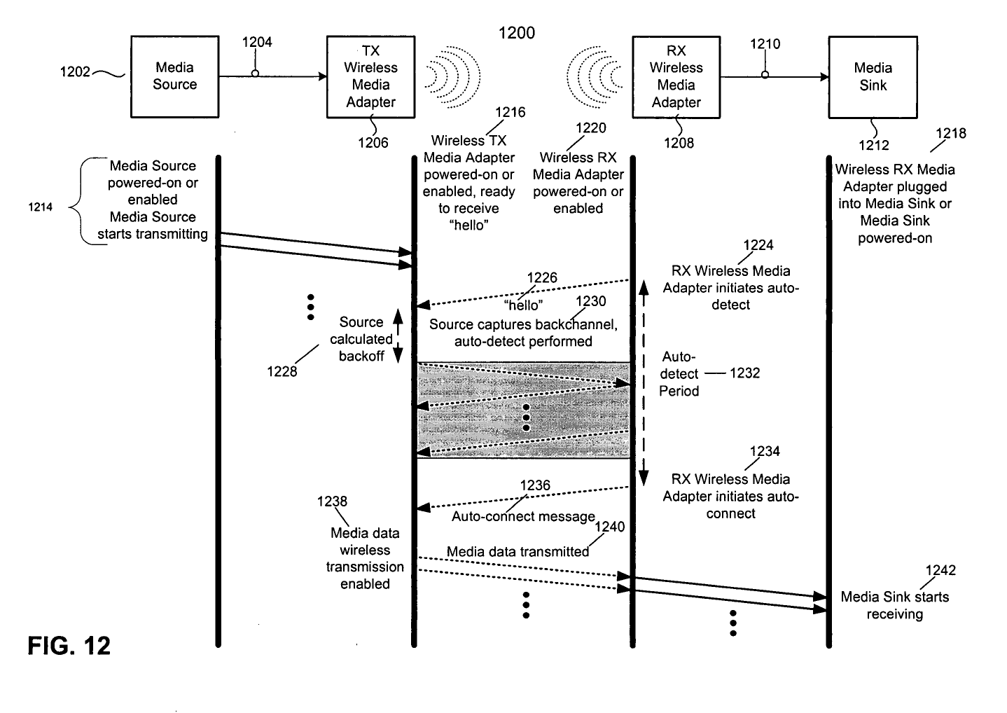

FIG. 12 illustrates an auto-detect and auto-connect process of the present invention used by a wireless analog media delivery system 1200. As shown in FIG. 12, the wireless analog media delivery system 1200 includes a media source 1202. The media source 1202 generates analog audio and video content or data 1204 and provides the analog audio and video content 1204 to a wireless transmitter media adapter 1206. The wireless transmitter media adapter 1206 performs all physical and MAC layer wireless functionality involved with the formatting and wireless transmission of the analog audio and video content 1204.

As further shown in FIG. 12, the wireless analog media delivery system 1200 includes a wireless receiver media adapter 1208. The wireless receiver media adapter 1208 performs all physical and MAC layer wireless functionality involved with the wireless reception and recovery of the analog audio and video content 1204. The wireless receiver media adapter 1208 provides recovered analog audio and video content 1210 to a media sink 1212.

The wireless analog delivery system 1200 uses a first RF channel, or wireless media channel, to transfer analog audio and video content while a second RF channel, or backchannel, is used to bi-directionally exchange MAC information, as described more fully above with reference to FIGS. 8, 9 and 10. Alternatively, the wireless analog delivery system 1200 can use a single RF channel for the transfer analog audio and video content and to bi-directionally exchange MAC information.

In accordance with the auto-detect and auto-connect process of the present invention, the media source 1202 is powered-on or enabled and immediately provides the analog audio and video data 1204 to the wireless transmitter media adapter 1206 at step 1214. At step 1216, the wireless transmitter media adapter 1206 is powered-on or enabled. The analog audio and video data 1204 provided to the wireless transmitter media adapter 1206 is not transferred over the media channel at this time.

At step 1218, the media sink 1212 is powered-on and immediately attempts to receive recovered analog audio and video content 1210 from the wireless receiver media adapter 1208. At step 1220, the wireless receiver media adapter 1208 is powered-on or enabled. The recovered analog audio and video content 1210 is not provided to the media sink 1212 by the wireless receiver media adapter 1208 at this time.

With both the wireless transmitter media adapter 1208 and the media sink 1212 powered-up, MAC processes denoted “auto-detect” and “auto-connect” are initiated and performed over the backchannel. For example, as shown in FIG. 12, after the wireless receiver media adapter 1208 is powered-on or otherwise enabled at step 1220, the wireless receiver media adapter 1208 initiates the auto-detect process as shown at step 1224.

An objective of the auto-detect process of the present invention is for the wireless receiver media adapter 1208 to determine the available media source-wireless transmitter media adapter combinations and to associate an address with each combination or media source. The auto-connect process of the present invention is then used by the wireless receiver media adapter 1208 to select one of the available media source-wireless transmitter media adapter combinations from which it will receive analog audio and video content.

As shown in FIG. 12, the first step in the auto-detect process is for the wireless media receiver adapter 1208 to broadcast a “hello” frame at step 1226. This broadcast, for example, could be performed using the Consumer Electronics Control (CEC) frame format with destination logical address field set to 0b1111, as described in Version 1.1 of the HDMI Specification at pages CEC-10, the entirety of which is incorporated by reference as if fully set forth herein.

After the broadcast of the hello frame at step 1226, each wireless transmitter media adapter will begin a contention process for the backchannel. In one aspect of the present invention, each of the wireless transmitter media adapters is initialized with a random number used to determine how long it will wait before attempting to respond to the “hello” frame. The random number may be set, for example, by the manufacturer of the wireless transmitter media adapters. This calculated time period may be referred to as “the backoff period,” and is indicated in FIG. 12 by the reference numeral 1228.

A successful response to the hello frame by a particular wireless transmitter media adapter, for example the wireless transmitter media adapter 1206, triggers a set of transmissions between the wireless transmitter media adapter 1206 and the wireless transmitter media adapter 1208. This set of transmissions allows address and capability information to be exchanged between the wireless transmitter media adapter 1206 and the wireless transmitter media adapter 1208. During the time over which this set of frames is sent, the wireless transmitter media adapter 1206 is said to have “captured” the backchannel. Only the wireless transmitter media adapter that captures the backchannel can transmit over the channel until it “frees” the channel. These events are generally indicated at step 1230 of FIG. 12.

If a first wireless transmitter media adapter captures the backchannel before a second wireless transmitter media adapter, the second wireless transmitter media adapter will wait until the backchannel becomes free before re-attempting to capture the backchannel. Once the backchannel is freed by the first wireless media adapter, the second wireless media adapter generates a new random number. The newly generated random number is used to determine a new transmission time for responding relative to the end of the first set of transmissions.

This wait and re-attempt response process is repeated until each wireless transmitter media adapter has an opportunity to capture the backchannel and all address and capability information is fully exchanged. Alternatively, the wait and re-attempt response process is repeated until the expiration of a specified time, as measured relative to when the hello message was sent. This specified time is considered the “auto-detect period” and is denoted in FIG. 12 by reference numeral 1232. At the end of the auto-detect period 1232, the wireless receiver media adapter 1208 will initiate the auto-connect process at step 1234. The wireless receiver media adapter 1208 can initiate the auto-connect process at step 1234, for example, after a 1 second auto-detect period 1232, even if some of the wireless transmitter media adapters have not successfully captured the backchannel.

In one aspect of the present invention, each transmitted backchannel frame requires acknowledgement and, if a particular frame is not acknowledged, the frame is re-sent after a set number of frames. This acknowledgement procedure can be implemented, for example, using a CEC-specified acknowledgement procedure. Further, if a fixed number of retries are each unsuccessful, a wireless transmitter media adapter will assume that its attempt to capture the backchannel has failed and subsequently restarts the contention process to attempt to capture the backchannel until the auto-detect period has expired.

Once the auto-detect period 1232 is complete, the wireless receiver media adapter 1208 uses a deterministic process to initiate auto-connect 1234 with one of the identified media source-wireless transmitter media adapter combinations. For example, the selected media source-wireless transmitter media adapter combination might be the one with the lowest assigned address. Once the media source-wireless transmitter media adapter combination is chosen, the wireless receiver media adapter 1208 at step 1236 sends the selected media source-wireless transmitter media adapter combination an auto-connect control message.

Reception of the auto-connect message by the wireless transmitter media adapter 1206 allows the wireless transmitter media adapter 1206 at step 1238 to transmit analog audio and video content 1204 over the wireless media channel. Consequently, the analog audio and video content 1204 is transferred from the wireless transmitter media adapter 1206 to the wireless receiver media adapter 1208 at step 1240. The transmitted analog audio and video content 1204 is received by the wireless receiver media adapter 1208 and the recovered analog audio and video content 1210 is provided to the media sink 1212 at step 1242. A “paired (auto-connected) connection” is formed at step 1242 between the media source 1202-wireless transmitter media adapter 1206 combination and the wireless receiver media adapter 1208-media sink 1212 combination.

If the wireless receiver media adapter 1208 fails to receive any responses from a wireless transmitter media adapter or fails to find any unpaired/unconnected wireless transmitter media adapters, the wireless receiver media adapter 1208 can periodically re-broadcast the auto-detect data at a rate low enough not to interfere with other connected pairs within its transmission range. In case there are no media source-wireless transmitter media adapter combinations within its transmission range, the wireless media receiver adapter 1208 will send out a periodic “hello” message allowing the auto-connect process to occur periodically until a connection is made.

In one aspect of the present invention, a paired connection will last until broken by the wireless transmitter media adapter 1206 or the wireless receiver media adapter 1208. For example, the wireless transmitter media adapter 1206 can include a button that a user can use to switch between media sink-wireless transmitter media adapter combinations. Each time the button is pressed, the wireless transmitter media adapter 1206 will disconnect with the currently-paired media sink-wireless transmitter media adapter combination, reinitiate the auto-detect process, and auto-connect with a new media sink-wireless transmitter media adapter combination. Further, if either a media source or a wireless transmitter media adapter is disconnected, the wireless receiver media adapter 1208 will detect the lack of signal and initiate the auto-connect process.

In another aspect of the present invention, the wireless receiver media adapter 1208 can change a paired connection based on information or commands received on an alternate wired or wireless channel, including but not limited to an infrared (IR), IEEE 802.11 or Zensys communication channel.

In another aspect of the present invention, a paired connection can be broken when any element of the paired connection loses power. As will be appreciated by persons skilled in the art, various mechanisms can be employed by the wireless transmitter media adapter 1206 and/or wireless receiver media adapter 1208 to detect such an event. For example, the wireless receiver media adapter 1208 can monitor received signal power to detect the absence of a wireless transmission from the wireless transmitter media adapter 1206. Alternately, the backchannel can be used to carry periodic beacons from the wireless transmitter media adapter 1206 and/or the wireless receiver media adapter 1208. Absence of a periodic beacon will signal that either the wireless transmitter media adapter 1206 or the wireless receiver media adapter 1208 has lost power.

In one aspect of the invention, when the wireless receiver media adapter 1208 discovers that the wireless transmitter media adapter to which it was auto-connected has lost power or become inoperable, the wireless receiver media adapter 1208 reinitiates the auto-detect process. If the wireless transmitter media adapter 1206 discovers that the wireless receiver media adapter to which it was auto-connected has lost power or become inoperable, the wireless transmitter media adapter 1206 will cease wireless media transmissions until it again hears a “hello” message from a wireless receiver media adapter.

The present invention implements the foregoing automatic pairing/connecting mechanisms using a semiconductor circuit without a software programmable processor. In accordance with the present invention, both the wireless transmitter media adapter 1206 and the wireless receiver media adapter 1208 use a fixed state machine (processor) which reads control data vectors from memory and uses the pre-defined fields of the control vectors (i.e., the bit fields) to directly drive the control signals in the semiconductor circuit needed to implement the above automatic pairing/connecting mechanisms.

In another aspect of the present invention, a manual rather than an automatic mechanism is used to wirelessly pair/connect the wireless transmitter media adapter 1206 and the wireless receiver media adapter 1208. Accordingly, external control data is received at the wireless receiver media adapter 1208 indicating the logical and physical identifiers of a wireless transmitter media adapter with which to pair/connect. If the specified wireless transmitter media adapter is already paired/connected, the wireless receiver media adapter 1208.breaks the pairing/connection by wirelessly sending un-pairing/disconnecting control data with the specified logical/physical identifiers to the selected wireless transmitter media adapter. The wireless receiver media adapter 1208 pairs/connects to the selected wireless transmitter media adapter by wirelessly sending pairing/connecting control data with the specified logical/physical identifiers to the selected wireless transmitter media adapter.

Conclusion

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. A system for wireless delivery of analog media, comprising:
a wireless transmitter media adapter to receive analog media in a native format from a media source, wherein the wireless transmitter media adapter converts the analog media from the native format to a transmission format for transmission over a wideband wireless channel; and
a wireless receiver media adapter to receive transmitted analog media, wherein the wireless receiver media adapter converts the transmitted analog media from the transmission format to the native format for delivery to a media sink.

2. The system of claim 1, wherein:
the wireless transmitter media adapter comprises a transmitter media adapter interface, wherein the transmitter media adapter interface receives the analog media in the native format from the media source over a first wired link and converts the analog media from the native format to the transmission format; and
the wireless receiver media adapter comprises a receiver media adapter interface, wherein the receiver media adapter interface converts the transmitted analog media from the transmission format to the native format for delivery to the media sink over a second wired link.

3. The system of claim 2, wherein:
the wireless transmitter media adapter further comprises a wireless transmitter to transmit the analog media in the transmission format over the wideband wireless channel; and
the wireless receiver media adapter further comprises a wireless receiver to receive the transmitted analog media in the transmission format.

4. The system of claim 3, wherein:
the wireless transmitter further comprises an encoder, wherein the encoder encodes the analog media in the transmission format according to a Forward Error Correction (FEC) code prior to transmission; and
the wireless receiver further comprises a decoder, wherein the decoder decodes the transmitted analog media according to the FEC code.

5. The system of claim 4, wherein the FEC code is a Low Density Parity Check (LDPC) code.

6. The system of claim 3, wherein:
the wireless transmitter media adapter further comprises a first transceiver; and
the wireless receiver media adapter further comprises a second transceiver;
wherein the first and second transceivers exchange Media Access Control (MAC) information over a narrowband wireless channel.

7. The system of claim 6, wherein the narrowband wireless channel occupies a first frequency bandwidth different from a second frequency bandwidth occupied by the wideband wireless channel.

8. The system of claim 1, wherein the analog media comprises an analog video signal.

9. The system of claim 8, wherein a native format of the analog video signal is one of:
(a) a Super-Video (S-Video) format;
(b) a Color, Video, Blanking and Sync (Composite Video-CVBS) format;
(c) a YUV format; or (d) a Red-Green-Blue (RGB) format.

10. The system of claim 1, wherein the analog media comprises an analog audio signal.

11. The system of claim 10, wherein a native format of the analog audio signal is one of:
(a) an RCA line-level format; or
(b) an XLR line-level format.

12. The system of claim 1, wherein the transmission format is a High Definition Media Interface (HDMI) format.

13. An apparatus, comprising:
a media adapter interface to receive analog media in a native format from a media source and convert the analog media from the native format to a transmission format; and
a wireless transmitter to encode the analog media in the transmission format according to an FEC code for transmission over a wireless channel.

14. The apparatus of claim 13, wherein the media adapter interface comprises:
a video analog-to-digital converter and formatter (ADCF) to sample an analog video signal from the media source to produce a digitized analog video signal;
an audio ADCF to sample an analog audio signal from the media source to produce a digitized analog audio signal;
a multiplexer to receive the digitized analog video signal and the digitized analog audio signal to produce a composite signal; and
a period generator to format the composite signal according to the transmission format.

15. The apparatus of claim 14, wherein a native format of the analog video signal is one of:
(a) an S-Video format;
(b) a CVBS format;
(c) a YUV format; or
(d) an RGB format.

16. The apparatus of claim 15, wherein the video ADCF comprises:
a converter to convert the analog video signal of the S-Video format to a first digital video signal of an International Telecommunication Union (ITU) 656 format; and
a demultiplexer to demultiplex the first digital signal to produce the digitized analog video signal.

17. The apparatus of claim 14, wherein a native format of the analog audio signal is one of:
(a) an RCA line-level format; or
(b) an XLR line-level format.

18. The apparatus of claim 17, wherein the audio ADCF comprises a converter that decodes the analog audio signal from the RCA line-level format and outputs the digitized analog audio signal over an Inter-Integrated Circuit Sound (I2S) interface.

19. The apparatus of claim 14, wherein the wireless transmitter comprises:
a period processor to place training data into the composite signal formatted according to the transmission format to generate a processed composite signal;
an encoder to encode the processed composite signal according to the FEC code to generate an encoded composite signal;
an OFDM modulator to modulate the encoded composite signal to generate an output signal having an in-phase (I) component and a quadrature-phase (Q) component; and
an I/Q modulator to up-convert the I and Q components to the wireless channel.

20. The apparatus of claim 19, wherein the FEC code is an LDPC code.

21. The apparatus of claim 20, wherein the LDPC code has a code rate (R) of 0.8 and a length (K) of 4096.

22. The apparatus of claim 19, wherein the period processor places the training data into blanking intervals of the composite signal formatted according to the transmission format.

23. The apparatus of claim 13, wherein the wireless channel is a 0.3 GHz wide wireless channel.

24. The apparatus of claim 23, wherein the 0.3 GHz wide wireless channel occupies a range of frequencies selected from the set of frequencies reserved by the Federal Communications Commission (FCC) for Ultra-Wideband (UWB) operation.

25. The apparatus of claim 13, wherein the transmission format is an HDMI format.

26. An apparatus, comprising:
a wireless receiver to receive a radio-frequency (RF) input signal formatted according to a transmission format, wherein the wireless receiver demodulates and decodes the RF input signal to produce a composite signal formatted according to the transmission format; and
a media adapter interface to convert the composite signal from the transmission format to a native format for delivery to a media sink.

27. The apparatus of claim 26, wherein the wireless receiver comprises:
an I/Q demodulator to down-convert the RF input signal to produce a baseband signal;
an OFDM demodulator to demodulate the baseband signal to produce a demodulated baseband signal;
a decoder to decode the demodulated baseband signal according to an FEC code to produce a decoded composite signal;
a period processor to remove training data within the decoded composite signal to produce the composite signal formatted according to the transmission format.

28. The apparatus of claim 27, wherein the FEC code is an LDPC code.

29. The apparatus of claim 27, wherein the media adapter interface comprises:
a period generator to convert the composite signal from the transmission format to a multiplexed composite signal;
a demultiplexer to demultiplex the multiplexed composite signal into a digitized analog audio signal and a digitized analog video signal;
a video digital-to-analog converter and formatter (DACF) to provide an analog video signal formatted according to a native video format to the media sink; and
an audio DACF to provide an analog audio signal formatted according to a native audio format to the media sink.

30. The apparatus of claim 29, wherein the native video format of the analog video signal is one of:
(a) an S-Video format;
(b) a CVBS format;
(c) a YUV format; or
(d) an RGB format.

31. The apparatus of claim 30, wherein the video DACF comprises:
a multiplexer to multiplex the digitized analog video signal to produce a first digital video signal of an ITU-656 format; and
a converter to convert the first digital video signal to the analog video signal formatted according to the S-Video format.

32. The apparatus of claim 29, wherein the native audio format of the analog audio signal is one of:
(a) an RCA line-level format; or
(b) an XLR line-level format.

33. The apparatus of claim 32, wherein the audio DACF comprises an audio encoder and an I2S interface to convert the digitized analog audio signal to the analog audio signal formatted according to the RCA line-level format.

34. The system of claim 26, wherein the transmission format is an HDMI format.

35. An apparatus, comprising:
a base unit configured to use a wireless link;
an analog audio cable, a first end of the analog audio cable having a plurality of audio connectors and a second end of the analog audio cable coupled to a composite cable interface;
an analog video cable, a first end of the analog video cable having a plurality of video connectors and a second end of the analog video cable coupled to the composite cable interface;
a composite cable connected between the composite cable interface and the base unit, wherein the composite cable is structured to accommodate the analog video cable and the analog audio cable; and
a power cable connected to the base unit.

36. The apparatus of claim 35, wherein:
the analog video cable and the plurality of video connectors are structured according to an analog video format; and
the analog audio cable and the plurality of audio connectors are structured according to an analog audio format.

37. The apparatus of claim 36, wherein the base unit includes a transmitter configured to transmit over the wireless link a wireless composite signal having an audio component received from the analog audio cable and a video component received from the analog video cable.

38. The apparatus of claim 36, wherein the base unit includes a receiver configured to receive a wireless composite signal having an audio component for transmission by the analog audio cable and a video component for transmission by the analog video cable.

39. The apparatus of claim 36, wherein the analog video format is one of:
(a) an S-Video format;
(b) a CVBS format;
(c) a YUV format; or
(d) an RGB format.

40. The apparatus of claim 39, wherein the plurality of analog video connectors comprise a single S-Video connector.

41. The apparatus of claim 36, wherein the analog audio format is one of:
(a) an RCA line-level format; or
(b) an XLR line-level format.

42. The apparatus of claim 41, wherein the plurality of audio connectors comprise two RCA connectors.

43. The apparatus of claim 35, wherein the base unit further comprises a Light Emitting Diode (LED) to indicate the status of a wireless link between the base unit and a remote base unit.

44. The apparatus of claim 35, wherein the power cable is connected to a first side of the base unit that is opposite a second side of the base unit connected to the composite cable.

45. A method for transferring an analog media signal from a media source to a media sink, comprising:
(a) receiving an analog media signal in a native format from a media source;
(b) converting the analog media signal from the native format to a transmission format;
(c) transmitting the analog media signal in the transmission format over a wireless channel;
(d) receiving the transmitted analog media signal in the transmission format;
(e) converting the transmitted media signal from the transmission format to the native format to produce a recovered analog media signal; and
(f) providing the recovered analog media signal to a media sink.
